(19) United States
(12) Patent Application Publication
(10) Pub. No.: US 2025/0258975 A1
(43) Pub. Date: Aug. 14, 2025

(54) SYSTEM AND METHOD FOR CYBER TRAINING

(71) Applicant: HAIKU, INC., Henderson, NV (US)

(72) Inventors: Eric BASU, Henderson, NV (US); Vincent ALIQUO, Augusta, ME (US)

(21) Appl. No.: 19/171,014

(22) Filed: Apr. 4, 2025

Related U.S. Application Data
(63) Continuation-in-part of application No. 17/580,497, filed on Jan. 20, 2022.
Application No. 17/580,497 is a continuation-in-part of application No. 17/013,215, filed on Sep. 4, 2020, now Pat. No. 11,265,343.
(60) Provisional application No. 63/575,487, filed on Apr. 5, 2024.
(60) Provisional application No. 62/895,892, filed on Sep. 4, 2019.

(51) Int. Cl. G06F 30/20; G06F 9/451

(52) U.S. Cl. CPC G06F 30/20; G06F 9/451

(57) ABSTRACT

A system and method for facilitating various forms of cyber training. In some embodiments, the system and method enable the creation and deployment of cyber ranges. Such a cyber range can simulate one or more network environment(s) of one or more real or hypothetical organizations for various network, software, and system/hardware components, as well as simulations of various network traffic.

### CROSS-REFERENCE TO RELATED APPLICATIONS

This application claims priority to U.S. Provisional Patent Application Ser. No. 63/575,487, filed on Apr. 5, 2024, and is a continuation-in-part of co-pending U.S. patent application Ser. No. 17/580,497, filed Jan. 20, 2022, entitled “System and Method for Cyber Training,” which is a continuation-in-part of U.S. patent application Ser. No. 17/013,215, filed Sep. 4, 2020, entitled “System and Method for Cyber Training,” now U.S. Pat. No. 11,265,343 issued Mar. 1, 2022, which claimed priority to U.S. Provisional Patent Application Ser. No. 62/895,892, filed on Sep. 4, 2019, the contents of the applications are incorporated herein by reference in their entirety and for all purposes.

### FIELD

The present disclosure relates generally to computer-implemented training systems and methods and, more particularly, to systems and methods for training on a cyber range.

### BACKGROUND

Cyber-attacks and cyber threats include data breaches, individual identification threats, system outages due to hackers, and/or vulnerabilities detected to critical system infrastructures. The number of cyber-attacks is increasing at a staggering rate. For example, the global cost of data breaches is currently estimated at over $2.1 trillion with a cyber-attack occurring almost every thirty-nine seconds. Over three hundred thousand pieces of malware are created daily; over four hundred forty-four thousand ransomware attacks were approximated in 2018. Some estimates suggest that hackers can infiltrate a secured network in just about nineteen minutes.

As these cyber-attacks continue to increase, the need for security systems and trained cyber security experts to protect these information systems is growing just as fast. In fact, the rapidly growing cyber security threat is increasing the demand for personnel with experience to safeguard sensitive systems in both public and private sectors. About 3.5 million cyber security jobs are currently projected to be unfilled. However, properly training the personnel to fulfill these roles is currently lacking.

Current training methods are inadequate to provide the necessary teaching to safeguard critical systems. For example, conventional training methods include developing cyber ranges, which are interactive, simulated representations of a network, system, tool, and application that is connected to a simulated Internet level environment. However, these conventional cyber range development tools are fairly static and cannot easily replicate a wide range of network infrastructures found in various industries. Therefore, conventional training methods cannot transition between multiple environments and functions for rapid deployment and integration with various applications. Often, the static nature of these conventional tools is caused by the lack of proper resource allocation (e.g., server allocation) for use with various simulations. Instead, these tools are typically designed for a single target and a single industry and are often quickly outdated with new cyber threats.

As a further disadvantage, conventional systems and range building tools do not typically attract the average user by providing an approachable system. Although some efforts have been made to encourage friendly competition while training to approach cyber-attacks, games of this nature are physical in form, thereby limiting the accessibility to the average user and restricting the integration with dynamic scenarios.

Accordingly, there is a need for systems and methods for improved cyber security training and cyber range development in an effort to overcome the aforementioned obstacles and deficiencies of conventional cyber-attack training systems.

### BRIEF DESCRIPTION OF THE DRAWINGS

FIG. 1 is a top-level system diagram that illustrates an exemplary general architecture view of the system, according to various embodiments.

FIG. 2 is a flowchart showing exemplary data flow for interaction with the system by a user, according to various embodiments.

FIG. 3 is a top-level diagram that illustrates exemplary pool functionality, according to various embodiments.

FIG. 4 is a top-level sequence diagram that illustrates exemplary data flow for various operations which occur, and messages/communications which are sent among actors, according to various embodiments.

FIG. 5 is an exemplary user interface (UI) that illustrates a display screen for an antagonist player, according to various embodiments.

FIG. 6 is an exemplary UI which can be displayed in connection with indicating an identity of a team leader, and the quantities of players who are to comprise the teams of various rounds, according to various embodiments.

FIG. 7 is an exemplary UI which can be displayed once gameplay is underway, according to various embodiments.

FIG. 8 is an exemplary UI which can be displayed once the game has ended, according to various embodiments.

FIG. 9 is an exemplary UI which depicts drag and drop functionality for building/editing cyber ranges, according to various embodiments.

FIG. 10 is a diagram depicting interprocess communication which occurs when drag and drop functionality is utilized, according to various embodiments.

FIG. 11 is a flowchart showing another exemplary data flow for interaction with the system by a user, according to various embodiments.

FIG. 12 is a top-level system diagram that illustrates an exemplary general architecture view of the system of FIG. 1, according to various embodiments.

FIG. 13 shows an exemplary computer system that can be used with various embodiments.

FIG. 14 is an exemplary UI showing the environment for creating and simulating secure programmable network environments that can be used with various embodiments.

FIGS. 15A-F each shows an exemplary UI showing the environment for creating and simulating secure programmable network environments of FIG. 14 according to alternative embodiments.

FIGS. 16A-C each shows an exemplary flow diagram for walking through a step of the mission editor of the UI of FIG. 14 that can be used with various embodiments.

FIG. 17 shows an exemplary UI showing a training chat interface according to various embodiments.

FIGS. 18-22 each shows an exemplary UI showing the environment for creating and simulating secure programmable network environments of FIG. 14 according to various embodiments.

FIG. 23 shows an exemplary UI showing a list of functions as provided by the environment of FIG. 14 according to various embodiments.

FIGS. 24-26 each shows an exemplary UI showing the environment for creating and simulating secure programmable network environments of FIG. 14 according to various embodiments.

FIGS. 27-45 show exemplary player interfaces displayed to a trainee in an exemplary scenario.

FIGS. 46-52 show exemplary creator interfaces for building the exemplary scenario of FIGS. 27-45.

FIGS. 53-54 show exemplary creator interfaces displayed to a creator for building an exemplary network for creating the exemplary scenario of FIGS. 27-45.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

According to various embodiments, systems and methods are disclosed for facilitating various forms of cyber training. Such systems and methods can include ones in which cyber ranges can be created and deployed. Such a cyber range can, as just one example, be a simulation of the network environment(s) of one or more real or hypothetical organizations. The simulation can include various details, such as simulations of various network, software, and system/hardware components, as well as simulations of various network traffic. The simulations can include both benign and nefarious ones (e.g., malware and/or malicious network traffic can be simulated). In this way, both cyber defense and white hat cyber-attack skills can be honed in a safe environment, in either or both of guided and free play ways. Various aspects will now be discussed in greater detail.

### General Architecture/Operation

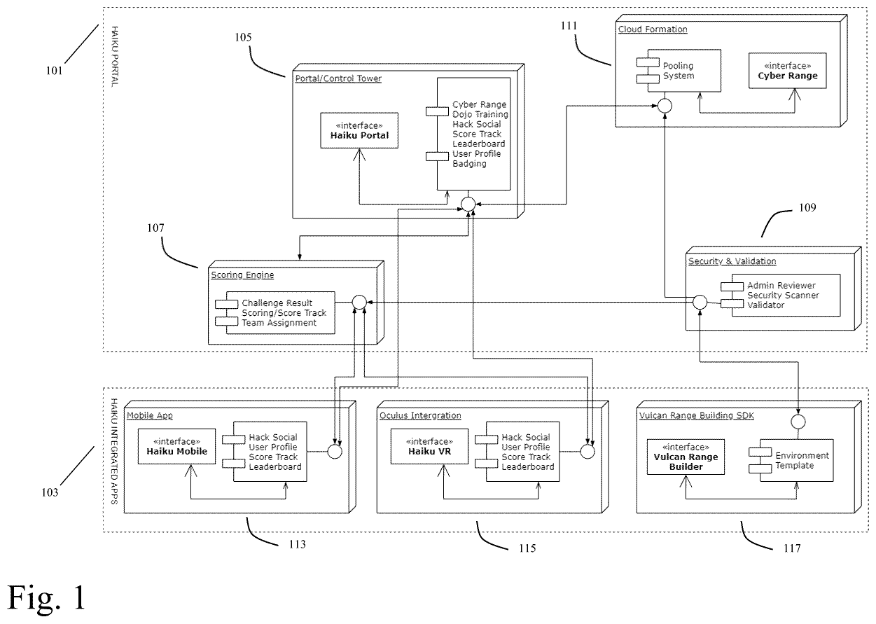

Turning to FIG. 1, a general architecture view of the system is shown, including portal module group 101 and integrated applications (apps) module group 103. As depicted, the portal module group 101 can include a portal/control tower module 105, a pooling/cloud formation module 111, a scoring engine module 107, and a security and validation module 109. As also depicted, the integrated apps module group 103 can include a mobile app module group 113, an immersive computing (e.g., a virtual/augmented reality system such as Oculus) integration module 115, and a range building software development kit (SDK) module 117.

As illustrated by FIG. 1, the portal/control tower module 105 can provide capabilities including a cyber range, dojo training, a hack social, a score track, a leaderboard, one or more user profiles, and badging. As also illustrated by FIG. 1, the scoring engine module 107 can provide capabilities including challenge result, scoring/score track, and team assignment. As additionally illustrated by FIG. 1, the pooling/cloud formation module 111 can provide capabilities including pooling system capabilities. Moreover, the security and validation module 109 can provide capabilities including administrator (admin) review, security scanning, and validation. The mobile app module 113 and the immersive computing integration module 115 can each provide capabilities including a hack social, user profiles, score track, and leaderboard. Further still, the range building SDK module 117 can provide capabilities including environment template capacities. Hereinbelow, additional discussion of various of the modules of FIG. 1 is provided.

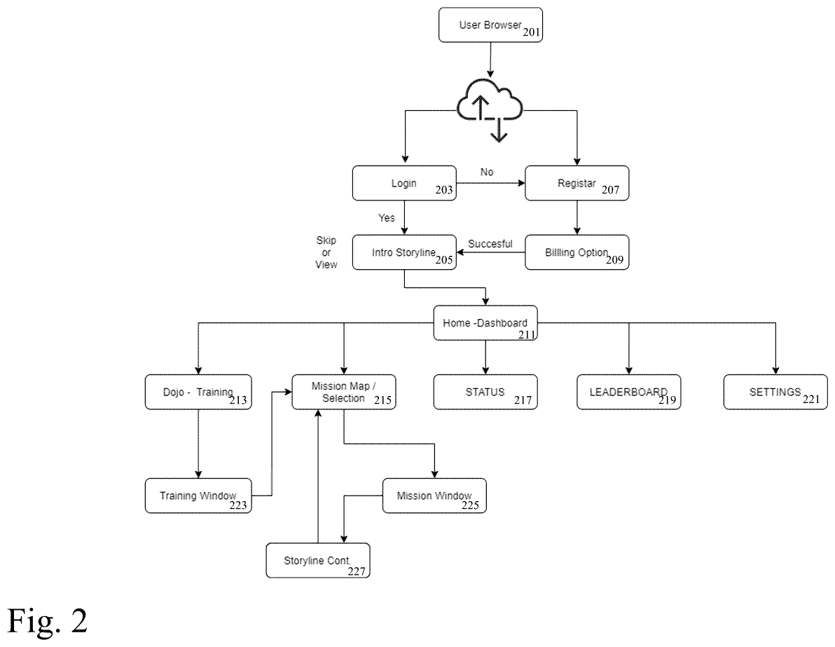

Turning to FIG. 2, shown is a flowchart regarding interaction with the system by a user. At step 201, the user can access the system via a web browser, app, or other modality. The system can be implemented in a cloud-based manner. If the user is an existing user, the user can log in at step 203, and then opt to either view or skip a storyline introduction at step 205. The storyline introduction can provide a scenario for the cyber training that the user is to experience (e.g., that an attack on the computer infrastructure of a particular power grid is expected). If the user is not an existing user, the user can register at step 207, provide billing information at step 209 (in some embodiments), and then proceed to discussed step 205.

After viewing or skipping the storyline intro at step 205, the user can proceed to the home dashboard at step 211. From here, the user can select various destinations including dojo training 213, mission map selection 215, status information 217, leaderboard viewing 219, and settings selection 221. As depicted by FIG. 2, from the dojo training of step 213 the user can proceed to training window 223. As shown by FIG. 2, from training window 223 the user can proceed to noted mission map selection 215.

Also referring to FIG. 2, from mission map selection 215 the use can proceed to mission window 225, onward to a storyline continuation at step 227, and then can return to mission map selection 215.

### Portal/Control Tower, Scoring Engine, and Security and Validation Modules

With reference to FIG. 1, the portal/control tower module 105 allows users to transition between multiple environments and functions seamlessly and without interruptions. In some embodiments, the portal/control tower module 105 supports and coordinates one or more modules including modules 107-115, thereby enabling fast load times, rapid deployment, minimized user wait time, and integration with multiple apps. As mentioned, the portal/control tower module 105 can also provide capabilities including cyber range, dojo training, hack social, score track, leaderboard, user profile, and badging.

The scoring engine module 107 enables seamless integration with third-party cybersecurity capture-the-flag (CTF) software modules, templates and/or scripts to provide quick and easy access and interchangeable integration with portal/control tower module 105. Further, the scoring engine module 107 allows a user of a given cyber range to complete simulated tasks that realistically mimic real world tasks of the sort performed by cybersecurity offensive and/or defense professionals. The scoring engine module 107 realistically scores the user based upon their ability to complete those tasks.

As an example, in scoring the user, the scoring engine module 107 checks the states of one or more files and compare those file states to one or more specified file end states that indicate that a given cybersecurity challenge (or part thereof) has been completed. As another example, the scoring engine module 107 can query one or more machine states (e.g., including user permissions, file placements, file deletions, and/or overall machine permissions), and compare those machine states to one or more corresponding baseline machine states to determine if a given cybersecurity challenge (or part thereof) had been completed. As a further example, the scoring engine module 107 can check for an open “back door” (e.g., a way of accessing an otherwise secure computer covertly) to see if the user implemented the back door in a correct way that allows successful completion of a given cybersecurity challenge (or part thereof). In various embodiments, the scoring engine module 107 can operate as part of the process of a user completing a given range. More generally, the scoring engine module 107 can operate in connection with and be configured for ranges built using the Vulcan range-building tool. As mentioned, the scoring engine module 107 can also provide capabilities including challenge result, scoring/score track, and team assignment.

Returning to the security and validation module 109, this module provides functionality including validating and reassuring security for submitted environmental templates from the range building SDK module 117. The security and validation module 109, in an aspect, sets a pre-approved process before administrators of the system give (e.g., via a UI provided by the system) final sign-off of templates submitted by third-party (or other) range builder developers.

### Pooling/Cloud Formation Module

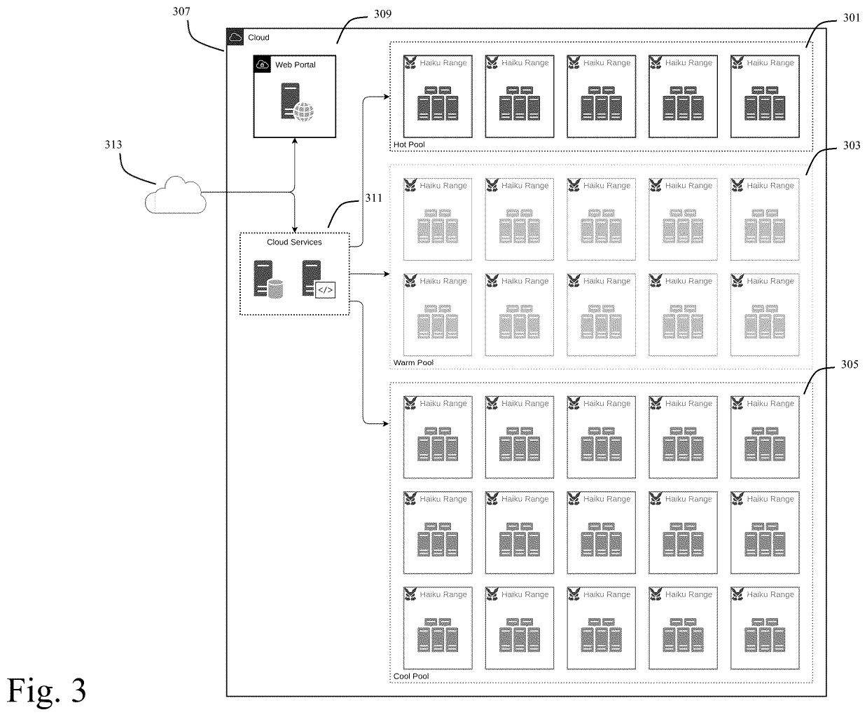

With further regard to pooling/cloud formation module 111, this module provides for functionality including speeding up the end-user experience of accessing a given cyber range. Turning to FIG. 3, shown is a diagram depicting pool functionality facilitated by the pooling/cloud formation module 111. The pooling/cloud formation module 111 can allocate one or more pools, such a hot pool 301, a warm pool 303, and a cool pool 305. As shown in FIG. 3, the pools 301-305 are deployed within a cloud 307, and in connection with a cloud-deployed web portal 309 and one or more cloud-deployed cloud services 311. A network 313 of FIG. 3 can represent operable connection with the general Internet, one or more local networks, and/or with further cloud deployments.

In some embodiments, the hot pool 301 includes one or more servers (virtual and/or physical) that are active, have active cyber range instances running thereupon, and where users are actively using those cyber range instances.

The warm pool 303 can include one or more servers (virtual and/or physical) that are active and have active cyber range instances running thereupon, but where users are not actively using those cyber range instances. Once one of these cyber range instances becomes marked by the system for active use by a user, the corresponding server(s) can be moved from the warm pool 303 to the hot pool 301.

Then, the cool pool 305 comprises servers (virtual and/or physical) that are inactive, but ready to be spun-up to a status of being active with an active cyber range instance running hereupon. Where one of these cyber range instances becomes marked by the system for active use by a user (e.g., where there is no available warm pool cyber range instance for the user), the corresponding server(s) can be moved from cool pool 305 to hot pool 301 (or in various embodiments first from cool pool 305 to warm pool 303, and then onward to hot pool 301).

Control logic which the system can apply in controlling the functionality of pools 301-305 will now be discussed. When a user connects and wants to start a cyber range, the system can determine whether the warm pool 303 includes a server running an instance of the desired cyber range. Where the system finds such as server, it can mark the relevant cyber range instance for use by the user and can move the corresponding server to the hot pool 301. Where the system finds no such server, it can act as discussed above.

Additionally and/or alternatively, the system can check, for example, against predetermined minimum and maximum values, the number of servers in the warm pool 303 and the cool pool 305. Where the system finds that the number of servers in either of these two pools has fallen below the minimum value, the system can trigger the instantiation of the called-for quantity of servers in the relevant ones of these two pools. If the number of available servers in the warm pool 303 or the cool pool 305 is above the maximum number, the system can perform server deletion and/or move operations. By way of example, where the quantity of servers in cool pool 305 is too high, the system can delete an appropriate quantity of servers from this pool until the number of servers is under the predetermined maximum. As another example, where the quantity of servers in warm pool 303 is too high, the system can perform one or more of: a) deleting an appropriate quantity of servers from warm pool 303; and/or b) moving an appropriate quantity of servers from the warm pool 303 to the cool pool 305.

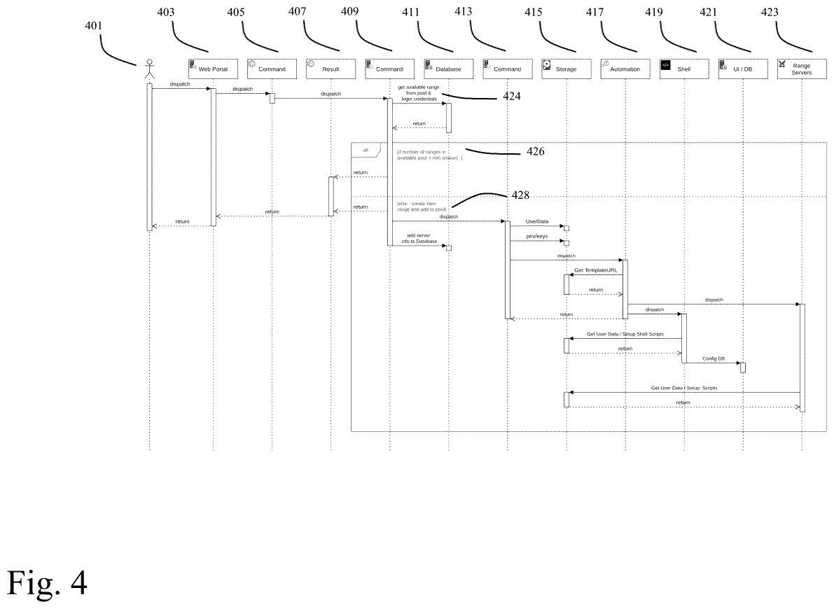

Turning to FIG. 4, a sequence diagram regarding various operations which occur, and messages/communications which are sent among actors, when a user 401 desirous of utilizing a given cyber range is satisfied by a range server(s) 423 is shown. The actors can include a user 401, a web portal 403, a command 405, a result 407, a command 409, a database 411, a command 413, a storage 415, an automation 417, a shell 419, a UI/database 421, and one or more range server(s) 423. Similar to the operation of the hot pool 301, the warm pool 303, and the cool pool 301, it is noted that among the messages/communications depicted by FIG. 4 is a message/communication 424 that depicts accessing a relevant cyber range instance of a corresponding pool, including the sending of login credentials of user 401. Similarly, among the operations depicted by FIG. 4, operations 426 and 428 illustrate the instantiation of servers for a given pool where the number of servers in that pool has fallen beneath the corresponding threshold.

### Social Engineering Game

According to various embodiments, the system can provide a computerized social engineering game to player users. The social engineering game can be implemented as a stand-alone entity or be integrated into a larger or different computerized game, where the outcome of the social engineering game can influence the path of the other computerized game. The social engineering game can serve to train players in thinking along the lines of social engineering scenarios. As will be discussed, a given player can play either the role of an antagonist or a protagonist. An antagonist player can use social engineering skills to deceive protagonist players, and protagonist players can identify the usage of social engineering skills by antagonist players. In this way, the players can become more aware of social engineering tactics if used against them in real life (e.g., in an attempt by criminals to gain disallowed access to information and/or network resources).

Setup of a particular instance of the game can include the system presenting a user interface (UI) which depicts—for instance via graphic images/icons of people—each of the n players who are to participate in the game instance. In various embodiments, the value of n can be at least 5. In other embodiments, the value of n need not be subject to this constraint. The players can include user players who are randomly selected or pre-selected by the system. For example, the system can draw such user players from a pool of users who have indicated to the system (e.g., via the UI) a desire to participate in a game instance. Further, the players can include artificial intelligence (AI)-controlled entities provided by the system, such as non-player characters (NPCs). In various embodiments, such an AI-controlled player can be implemented via one or more machine learning (ML) approaches. As just some examples, such ML approaches can include one or more of reinforcement learning techniques, recurrent neural network layers, neural embeddings (e.g., word embeddings), and/or generative learning techniques. In other embodiments, such an AI-controlled player can be implemented via rule-based approaches and/or via approaches that are not ML-based. Such employ of an AI-controlled player can offer benefits including flexibility in gameplay and training levels.

In some embodiments, players can be defined by one or more roles. For example, the system can randomly and secretly assign each player to either a protagonist role or an antagonist role. In variously assigning protagonist and antagonist roles to the players, the system can adhere to one or more ratios. The system can act such that the quantity of protagonists outnumbers the antagonists. As just some examples, such a protagonist:antagonist ratio can include 1.5:1 (or roughly 1.5:1) or 5:2 (or roughly 5:2). Implementation can be such that the system only informs (e.g., via a UI) antagonist players of the true identities (i.e., in terms of being antagonists or protagonists) of all players in the game, including the other antagonists. As such, this knowledge can be unknown to the protagonists. As discussed hereinbelow, protagonists play the role they represent in the game session. As such, protagonist players honestly convey themselves to be protagonists when interacting with other players. In contrast, players who are antagonists generally intentionally and secretly misrepresent the role they are supposed to play in the game. As such, antagonist players generally dishonestly convey themselves to be protagonists when interacting with protagonist players.

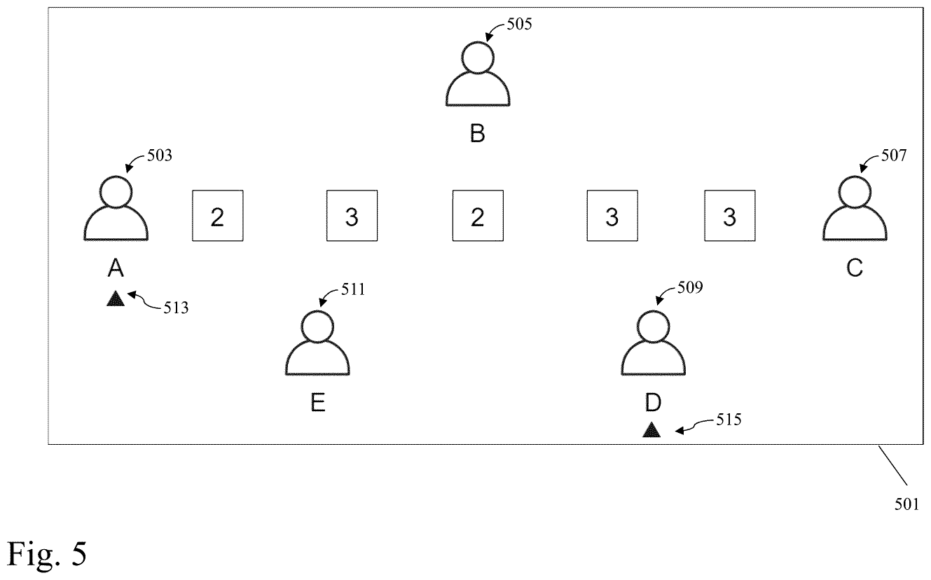

Turning to FIG. 5, shown is an example UI 501. The UI of Fig. α illustrates the display for an antagonist player. According to the example of FIG. 5, five players A-E are shown. In keeping with this, the system displays, via the UI, graphic images/icons 503-511, each of which corresponds to a given one of the five players A-E, respectively. Next to each of graphic image/icon 503 and 509, the system displays a pointer image/icon (513, 515). In this way, the system indicates that the player A corresponding to graphic image/icon 503 and the player D corresponding to graphic image/icon 509 are antagonists. The system can present the UI of 501 to each of those two players.

After setup, the system can commence gameplay. Here, in one aspect, the system can choose one of the players to be a team leader for the first round. Later, the system can choose a team leader for each of subsequent rounds. The team leader chosen by the system can for a given round be either a protagonist or an antagonist. The system can select the quantity of rounds which are to be played.

As one example, the system can randomly choose a team leader for a given round (e.g., for the first round). As another example, the system can assign numbers to players, and the player whom the system chooses as team leader for a given round can be based on a correlation between the number of the round and the chosen player number (e.g., the system can select player #1 as team leader for the first round, select player #2 as team leader for the second round, and so on). Such number assignment can involve the system randomly assign consecutive numbers to each player at the beginning of the game.

Further, the system can display a UI that shows the quantity of players. This quantity of players can indicate how many players the team leader is to assemble to go on the “mission” of the round (e.g., a first “mission” where the round is the first round). For a given team for a given round, the team leader for that round can be—but does not have to be—one of the team members. Further information regarding a mission is discussed hereinbelow.

The team leader for a given round can propose a certain set of players as the team of the round via a UI. Once the team leader has proposed the set of players for the team, the entire group of players can utilize a UI provided by the system to vote to approve or disapprove of the team. As just one example, a majority vote can be sufficient to approve the proposed team. Where the proposed team is not approved, the system can choose a different user to be team leader. For instance, the system can select as team leader a user having a user number one higher than the user number of the initial team leader, or can randomly select a different user as team leader). In this way, a process of team leader selection, proposal of players for the team, and voting on such proposal can repeat until a team is approved.

The system can provide textual (e.g., text chat, short-messaging-service (SMS), electronic mail (e-mail), and so on), audio (e.g., Voice-Over-IP, Discord, and so on), and/or video communication (e.g., Zoom, WebEx, Google Hangout, Microsoft Teams) venues, which allow players to communicate with one another. As just some examples, players can use these communication venues to communicate with each other either or both of: a) prior to the team leader proposing a team composition; and b) subsequent to the system informing the players of the team composition proposed by the team leader, but prior to voting.

As reflected hereinbelow, it can be advantageous for the protagonist players to have as many protagonists on a team as possible. And, it can be advantageous for the antagonist players to have as many antagonists on a team as possible. For this reason, is can be strategically advantageous for a given player to seek to be included on the team by using the communications system to attempt to convince other player(s) (e.g., including the leader player) of such inclusion. Alternately and/or additionally, a given player can use the communication system to attempt to convince other player(s) (e.g., including the leader player) that certain specified players should and/or should not be included on the team.

In some embodiments, the communications that occur in conjunction with team proposal and voting (i.e., in between each round) represent a game juncture where players can employ social engineering techniques, and/or can attempt to recognize the employ of social engineering techniques by other players. Employable social engineering techniques can include, as just some examples, intimidation, logic, empathy, guilt, and psychological manipulation. As an example, a given player can employ social engineering in “selling” the other players of that given player's role (true or otherwise). The system can impose no rules (or only limited rules intended to ensure game safety) regarding that which comprises an allowable social engineering technique.

As such, as just some examples the antagonist players can, utilizing the communication capabilities provided the system, employ social engineering techniques in attempt to secure as many antagonists on the team as possible. As some further examples, the protagonist players can, utilizing the communication capabilities provided the system, attempt to recognize the employ of social engineering techniques by antagonist players. Protagonists can, for instance, apply observation and/or logic to deduce who the antagonists are to protect themselves. Moreover, antagonists can, for instance, use subterfuge and/or deceit (e.g., to confuse and/or divide the protagonists in their ability to unite effectively and/or to mount a viable defense while staying hidden till the end of the game).

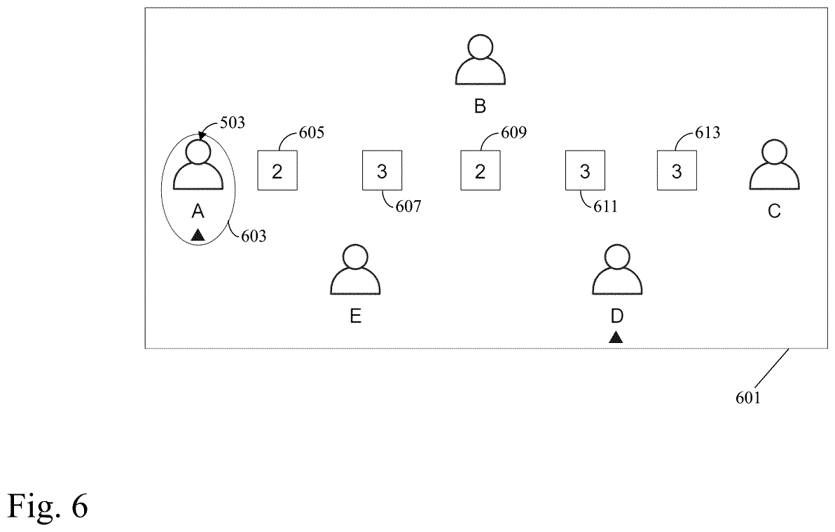

Turning to FIG. 6, shown is an example UI 601. The UI 601 indicates the identity of a team leader (i.e., player A), and the number of players who are to comprise the teams of various rounds. According to the example of FIG. 6, the system displays a circle 603 around a graphic image/icon 603. In this way, the system indicates that it has selected the player A corresponding to graphic image/icon 603 as the team leader for the current round. According to the example of FIG. 6, the first round is the current round.

Also in FIG. 6, the number of players who are to comprise the teams of various rounds are displayed via the numbers 605-613. Number 605—depicting a “2”—indicates that for the first/current round, the team leader (i.e., the player corresponding to graphic image/icon 503) is to propose two players for the team. Likewise, number 607, by depicting a “3”, indicates that the team leader for the second round is to propose three players. In like fashion, number 609 indicates that two players are to be proposed, number 611 indicates that three players are to be proposed, and number 613 indicates that three players are to be proposed.

Once a proposed team has been approved, the players which make up the team can proceed with the mission. Performance of the mission can involve the players voting in secret (e.g., via UI provided by the system) for the mission to be a success or a failure. As just one example, a mission can be considered successful by the system where all votes are for success, and be otherwise considered a failure (e.g., a single vote for failure can cause the system to consider the mission a failure.

In the context of the game, scoring can be such that the mission being a success scores a point for the protagonists, while the mission being a failure scores a point for the antagonists. In line with this, as noted, it can be advantageous for the protagonist players to have as many protagonists on a team as possible, and it can be advantageous for the antagonist players to have as many antagonists on a team as possible. In various embodiments, the system can cast (e.g., via UI) such mission success/failure in the context of a storyline, such as an infosec storyline. As an illustration, such an infosec storyline might specify that a vote for mission failure can comprise an organization experiencing an infosec security breach (e.g., an exploitation of a port vulnerability, a username discovery, or a theft of user credentials). Such storyline aspects (e.g., that which a vote for mission failure represents) and be customizable (e.g., via a UI provided by the system), thereby allowing for customized scenarios.

As the mission being a success scores a point for the protagonists, a protagonist player can be expected to vote for mission success. In some embodiments, the system can limit voting for mission success (e.g., via a UI) to protagonists only. As the mission being a failure scores a point for the antagonists, an antagonist player can often be expected to vote for mission failure. However, an antagonist can also opt to vote for mission success, such as part of a time-extended social engineering/deception strategy (e.g., attempting, by way of voting for mission success, to convince the protagonist players that he/she is a protagonist, the antagonist hoping that doing so will accrue larger long-term rewards). The system can, in various embodiments, allow for communications between players before the vote. At least in these ways, the vote for mission success/failure represents a further game juncture where players can employ social engineering techniques, and/or can attempt to recognize the employ of social engineering techniques by other players. Once all the votes from the team members have been secretly submitted, the results of the voting can be revealed by the system (e.g., via a UI).

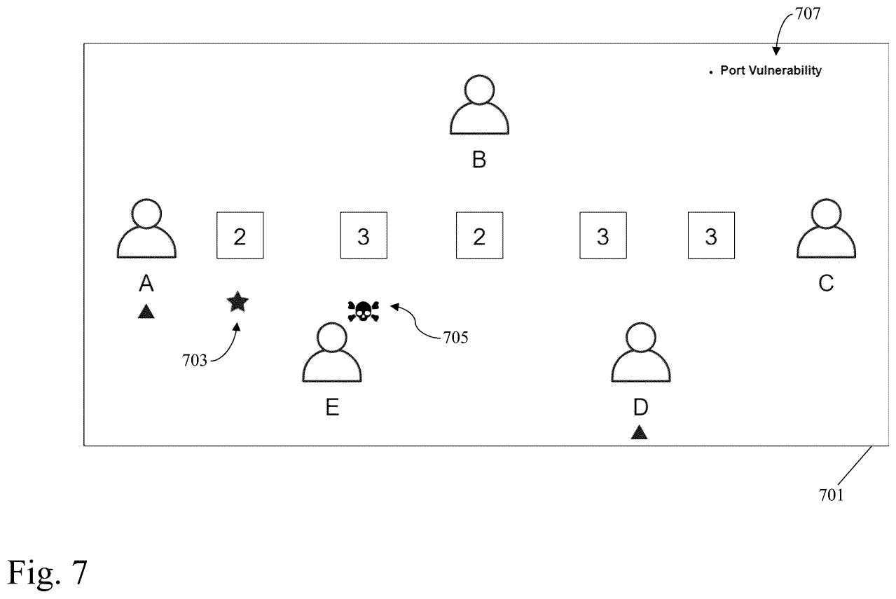

Turning to FIG. 7, an example UI 701 is shown, which the system can display once gameplay is underway. According to the example UI 701, the system presents a star graphic image/icon 703, indicating that round 1 resulted in a point for the protagonists. According to the example, this represents that all the team members—be they or antagonists (in secret hiding) or protagonists—voted for the mission of that round to be a success. Further, the system presents a skull graphic image/icon 705, indicating that round 2 resulted in a point for the antagonists. According to the example, this represents that at least one of the team members—an antagonist—secretly voted for the mission of that round to be a failure. Also in FIG. 7, the system presents a text element 707. With this text element 707, the system indicates that the mission failure of round 2 corresponds to an exploitation of a port vulnerability, according to a storyline of the game.

The game can continue in the discussed fashion until all the rounds have been played. The group—protagonists or antagonists—who have accrued the most victory point at the end of the game can win the game. The system can declare, via a UI, whether it is the protagonists or the antagonists who have won. As just some examples, winning the overall game can be represented in rank within game rosters, and/or by fictional currency or virtual currency (e.g., bitcoin). Such fictional or virtual currency can, for instance, be usable in the game to buy upgraded game features such as fancier icons.

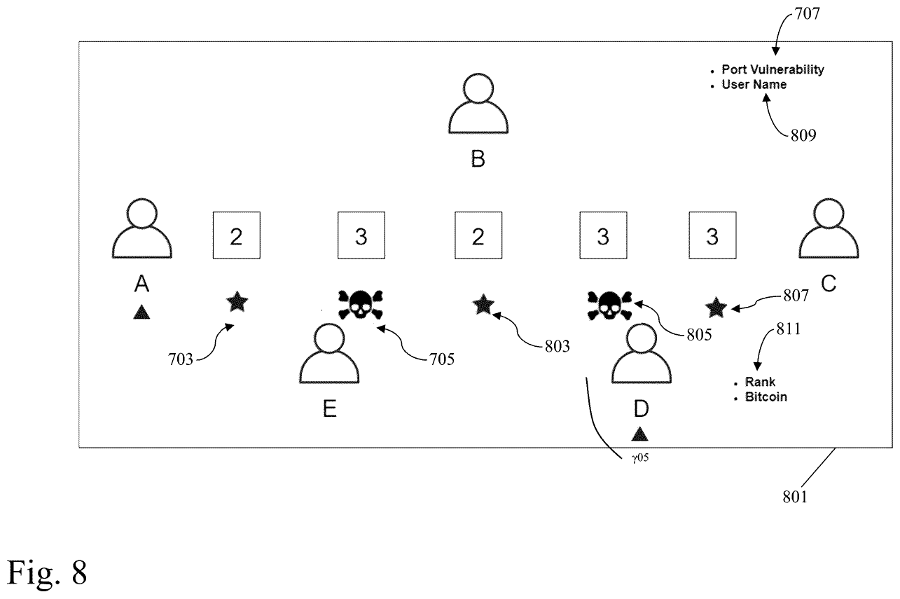

Turning to FIG. 8, shown is an example UI 801 which the system can display once the game has ended. Here, further to FIG. 7, presented are star graphic images/icons 803 and 807 showing that rounds 3 and 5 resulted in points for the protagonists, and skull graphic image/icon 805 showing that round 4 resulted in a point for the antagonists. Also further to FIG. 7, text element 809 indicates that the mission failure of round 4 corresponds to a username discovery, according to the storyline of the game. According to the example of FIG. 8, it is the protagonists who have won the game, as they have earned three points (via rounds 1, 3, and 5), while the antagonists have only earned two points (via rounds 2 and 4). Then, via element 811, the system indicates via the UI that winning protagonists have experienced a rise in rank and have earned bitcoin.

In this way, the social engineering game can provide an experience which is focused on strategy, verbal cues, and deduction. The social engineering game functionality can provide an effective and accessible way for people to learn and practice social engineering skills, so that they may become more aware of these tactics if used against them in real life. The social engineering game can simulate creativity and “on the fly” deduction and reaction that can be transferred and applied to both a real world, and virtual world scenario outside of the game.

### Vulcan Range-Building Tool

In some embodiments, the range building SDK module 117 can also provide a graphical user interface that enables users and developers to build their own cyber ranges, for example, in the cloud. The graphical UI can further provide a drag and drop interface. The user can select from the objects that will be used in the range from the drag and drop interface. The objects are dragged from the selection box on the left side of the screen and dropped onto the network diagram on the right side of the screen. Network connections between objects are created by selecting one object and dragging a line to another object. Right clicking the network connection allows the specification of the type of network protocol (i.e., IP, IPv6, NetBios, etc.).

Right-clicking an object after it is dropped into the range allows the selection from a drop down menu of vulnerabilities and flags unique to that object. By way of example, objects that can be dragged and dropped into a cyber range include, but are not limited to, routers, servers, printers, network switches, firewalls, databases, storage units, and so on. These objects can represent physical and/or virtual objects as desired.

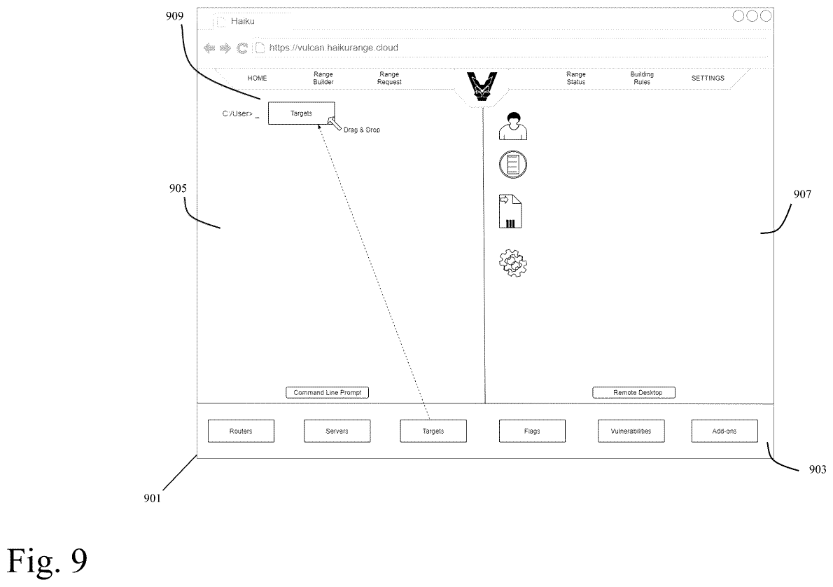

Turning to FIG. 9, depicted is a graphical UI 901 for building/editing cyber ranges. According to the example of FIG. 9, the user can utilize drag and drop functionality to resolve/configure new or existing elements of a cyber range. Depicted in FIG. 9 are cyber range elements 903, including “routers,” “servers.” “targets,” “flags,” “vulnerabilities,” and “add-ons.”

Here, the user has elected to resolve/configure a cyber range target. By dragging the cyber range target to command line prompt 905, the user can resolve/configure the chosen target in a command line prompt fashion. For example, after dragging the chosen target to command line prompt 905, various editable command line text can appear. By dragging the cyber range target to desktop 907, the user can receive from the UI one or more UI elements (e.g., dialog boxes) which allow the user to resolve/configure the chosen target. As depicted, according to the example of FIG. 9 the user has chosen to resolve/configure via command line prompt 905.

In various embodiments, implementation of the drag and drop functionality discussed herein can include generating (e.g., via the portal/control tower module 105 or the security and validation module 109) one or more lists of the types of objects, variables, challenges, vulnerabilities, and other entities that can be included in a range. Such a list can be defined by an organized format (e.g., a matrix or database). Utilizing the organized format, the system can, in response to drag and drop operations, combine these entities in specific ways to create a cyber range.

By way of example, the organized format (e.g., the matrix or database) can include specification of categories of challenges and of tags. The categories of challenges can, as just some examples, include: a) web; b) network compromise; c) binary; d) reverse engineering; e) cryptography; f) forensics; g) defensive; h) social engineering; and i) miscellaneous. The tags can, as just some examples, include Windows and Linux.

Also, for each of the various categories of challenge, the organized format can include specification of subcategories of technique/vulnerability and of tools available for tackling those subcategories. Turning, for instance, to the web category of challenge, as just some examples the subcategories of technique/vulnerability can include: a) SQL Injection; b) HTML headers; c) HTML changes; d) use of POST; e) viewing of source for clues; and f) Open Web Application Security Project (OWASP) top 10 web vulnerabilities. As just an illustration, the OWASP top ten web vulnerabilities can include: i) A01:2021—broken access control; ii) A02:2021—cryptographic failures (e.g., with renewed focus on failures related to cryptography which can lead to sensitive data exposure or system compromise); iii) A03:2021—injection (e.g., including cross-site scripting); iv) A04:2021—insecure design (e.g., with a focus on risks related to design flaws); v) A05:2021—security misconfiguration (e.g., including XML External Entities (XXE)); vi) A06:2021—vulnerable and outdated components; vii) A07:2021—identification and authentication failures/broken authentication (e.g., including common weakness enumerations (CWEs) that are related to identification failures); viii) A08:2021—software and data integrity failures (e.g., focusing on making assumptions related to software updates, critical data, and continuous integration/continuous development (CI/CD) pipelines without verifying integrity); ix) A09:2021—security logging and monitoring failures; and x) A10:2021—server-side request forgery.

In some embodiments, the corresponding tools available for use can include: a) Wrappalyzer; b) Builtwith; c) Retire.js; d) Burpsuite; e) OWASP zed attack proxy (ZAP); f) Dirtbuster; g) Gobuster; h) BeEF; and i) XXSHunter.

With reference to the network compromise category of challenge, as just some examples the subcategories of technique/vulnerability can include: a) finding credentials (e.g., pulling credentials from memory); b) evading AV and network detection; c) network scanning; d) privilege escalation; e) lateral movement; and f) pass the hash. Then, as just some examples, the corresponding tools available for use can include: a) Spiderlabs Spray; b) Ruler; c) SSH; d) NMAP; e) Ping; f) Responder; g) MultiRelay; h) PowerShell; i) Empire; j) Inveigh; k) Inveigh-Relay; l) CrackMapExec (CME); m) Metasploit; n) Mimikatz; o) Mimikittenz; and p) Armitage (GUI for Metasploit).

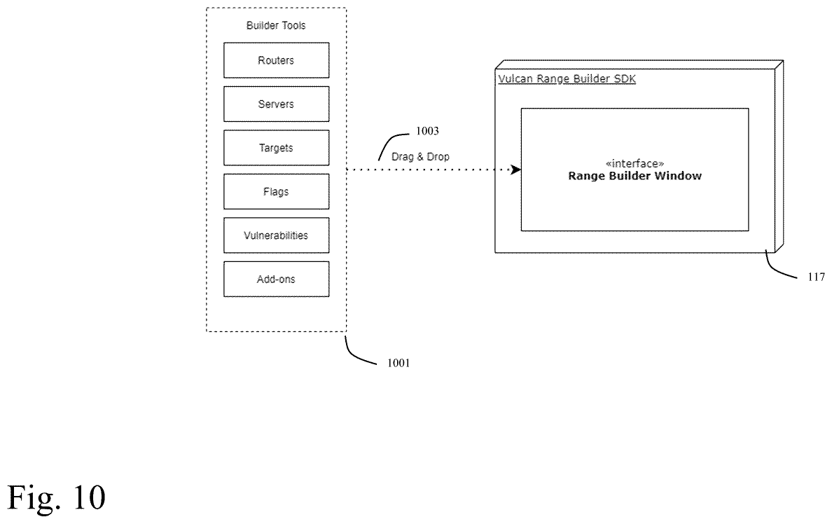

With reference to FIG. 10, depicted is inter-process communication which occurs when a user utilizes the discussed drag and drop functionality in building/editing a cyber range. In particular, the user can perform drag and drop with respect to one or more of the cyber range elements provided by builder tools 1001. In response, inter-process communication 1003 (e.g., one or more method calls) can provide range building SDK module 117 with information about the user action (e.g., indication of a particular cyber range element selected by the user, and the location to which the user has dropped the element).

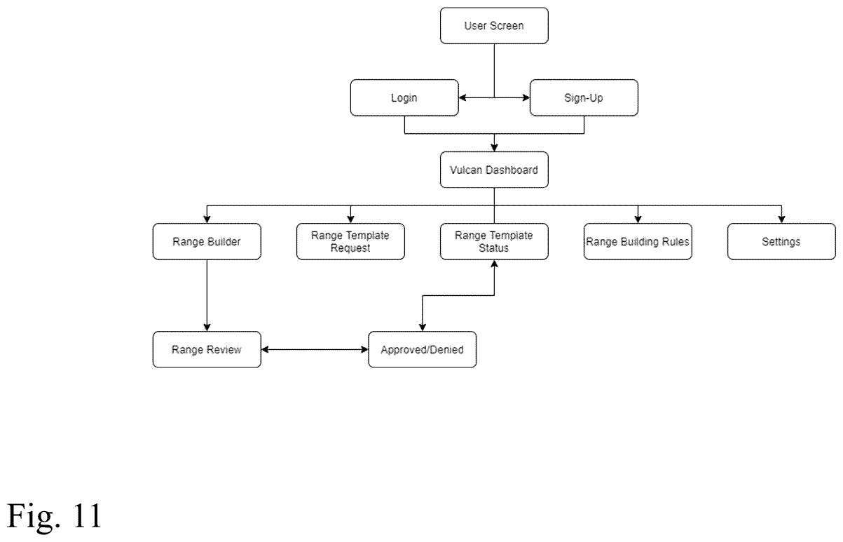

With reference to FIG. 11, the user has the ability to select from prebuilt range templates that can be modified, as well as the ability to create a new range from scratch.

The range building SDK module 117 advantageously allows range developers (from novice to expert users) to collaborate with and contribute to any number of cyber ranges for other users to exploit. These cyber ranges not only test one's skills in white hat hacking but also challenge those to build exploits for others to crack.

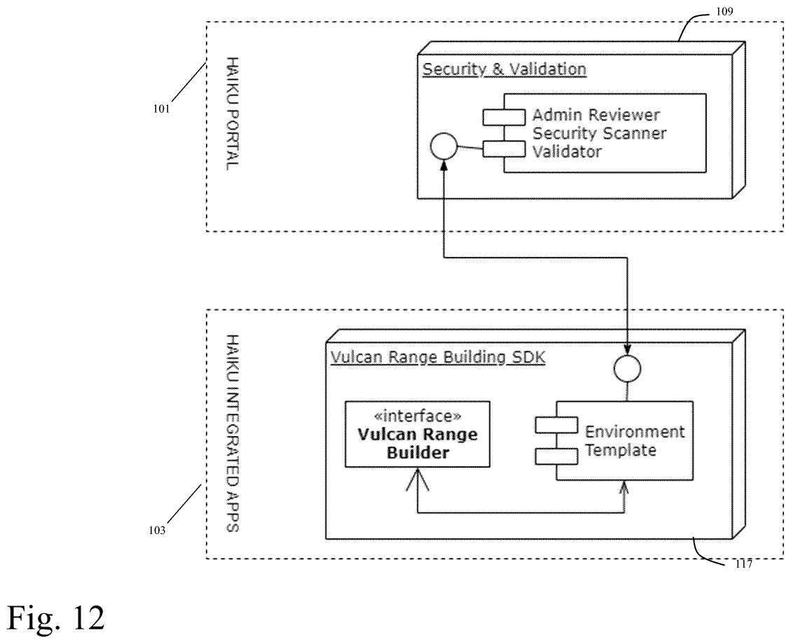

As previously discussed, the security and validation module 109 can provide administrator capabilities to review, scanning, and validate. With reference to FIG. 12, the security and validation module 109 cooperates with the range building SDK module 117 to validate submitted environmental templates from the range building SDK module 117, thereby reassuring security. Specifically, the security and validation module 109 sets a pre-approved process for administrators of the system to give (e.g., via a UI provided by the system) final sign-off of templates submitted by third-party (or other) range builder developers.

### Digital Twin

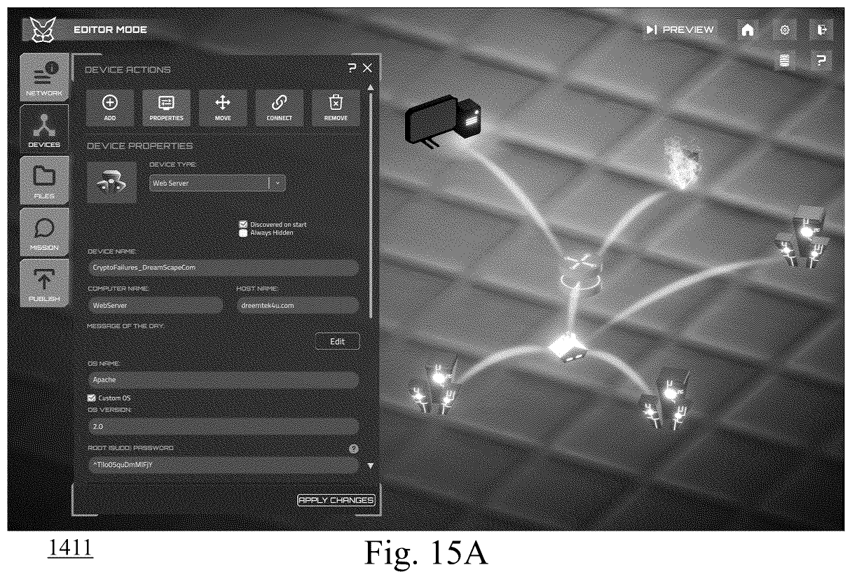

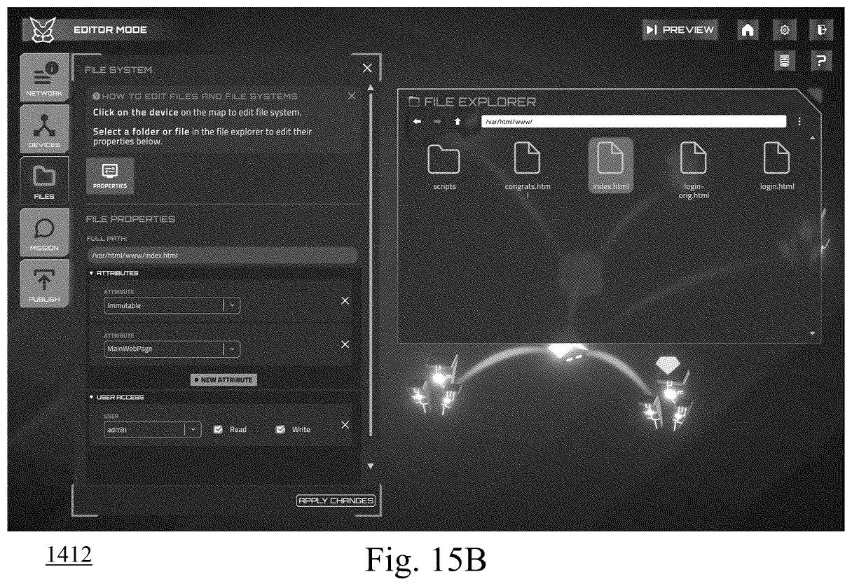

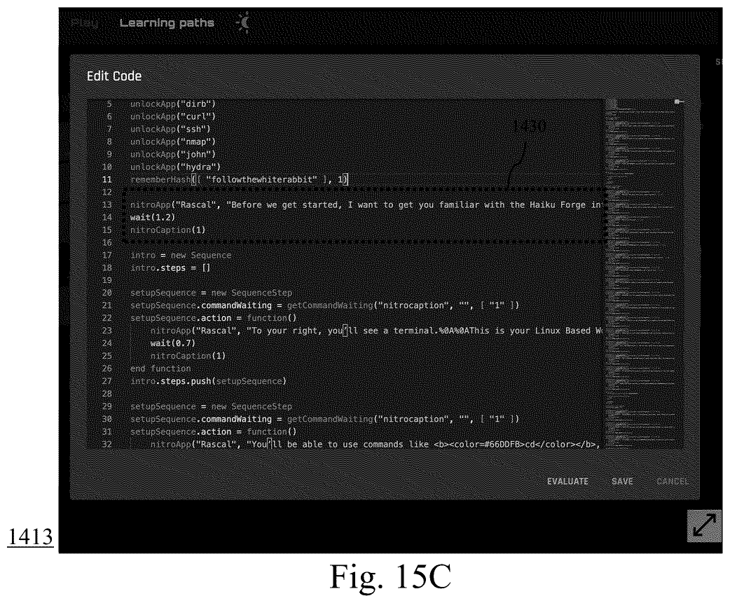

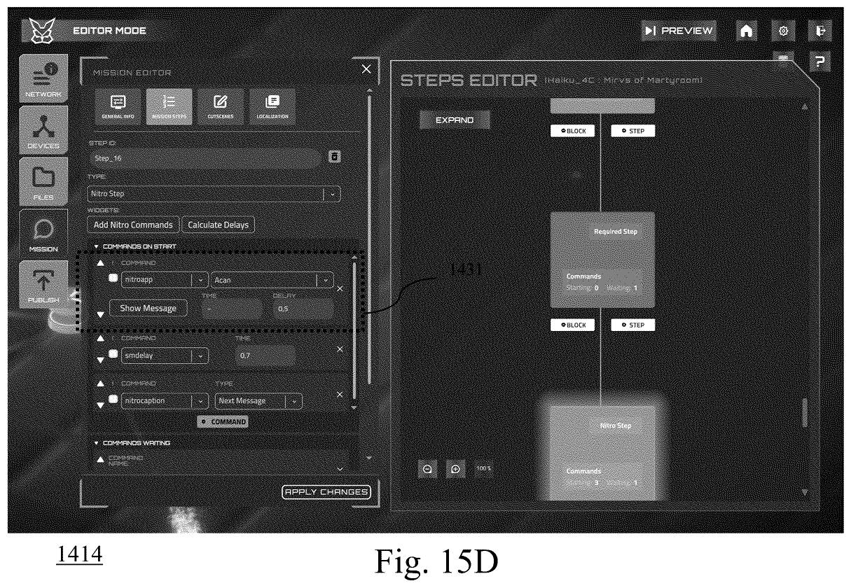

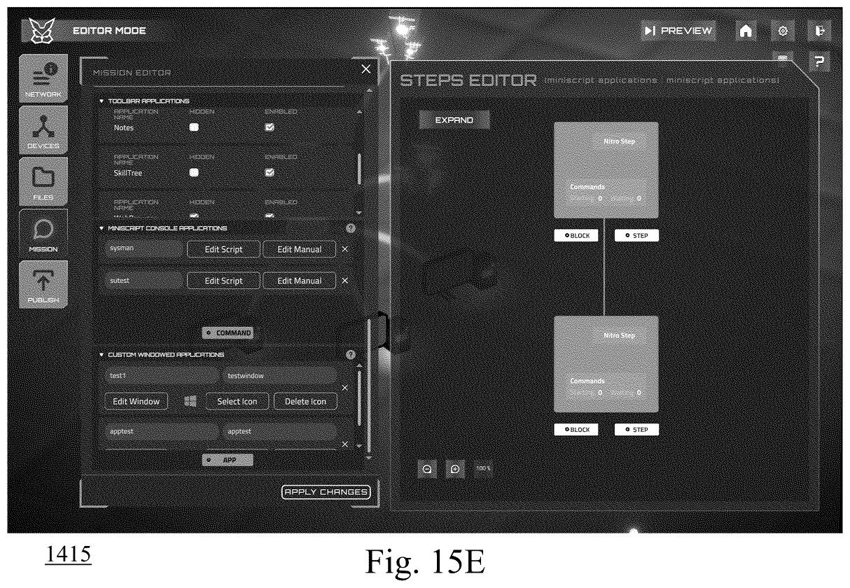

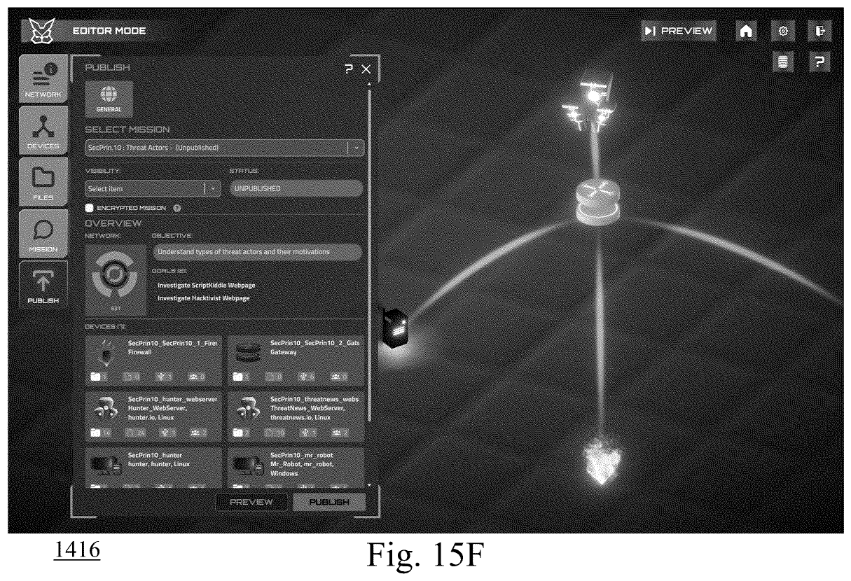

In some embodiments, the system can provide a graphical interface for creating and simulating secure programmable network environments. Turning to FIG. 14, an exemplary embodiment of the interface is shown. The interface includes a drag-and-drop interface 1409 with one or more configurable devices 1408 placed on a grid to allow users to build networks. By way of example, devices 1408 can include web servers, routers, printers, network switches, firewalls, databases, storage units, and so on. Scripted behaviors are generated by the system and stored in separate files. These separate files can be combined with encrypted network configurations to define network functionality. The system automatically generates device properties (e.g., IP (Internet Protocol) and MAC (Media Access Control) addresses) based on network topology and device type. Additionally, the devices 1408 can be configured to host websites and databases, and communication between devices is simulated and captured for analysis. Collaborative editing features allow multiple users to work on the same network and mission. Encryption ensures secure sharing and import/export within the platform. The platform can import real-time threat data into the system. The system allows for the visualization of threats in a safe, simulated environment that is accessible even if the organization's networks are not. The architecture supports stateful objects that interact in real time by automatically generating network properties based on topology and device type. Additionally, importing and visualizing live threat data advantageously and significantly enhances its utility for cybersecurity training and simulation. Exemplary embodiments of this interface are shown in FIGS. 15A-F.

Properties of the device can be edited from the edit device option 1404, such as shown in an interface 1411 in FIG. 15A, which presents options for the device properties in the configuration panel 1402. By way of example, these device properties of the edit device option 1404 can include the device type, its appearance and functionality, and setting whether the device should be discovered at the start of the mission (a scenario that engages with the network) or require activation through console tools. Each device 1408 can be automatically assigned a unique name upon creation, and its computer name can be obtained via console commands. Additionally, users can set the host name for accessing device services (for example, haikupro.com), which plays a role in the NAT (Network Address Translation) activation process. For routers, a network mask is available from a dropdown menu, facilitating IP address generation in a specified manner. If NAT is enabled, the router can be configured to activate its Wi-Fi module, where you may define the Wi-Fi network name, designate the network as public or private (with private as the default), and set the Wi-Fi network password. Moreover, if you opt for random password generation, the system will generate a new Wi-Fi password each time the network is engaged, with additional options to choose password length and complexity. Other properties include a message of the day that displays when connecting to a device, an operating system name selected from a dropdown (such as Linux or Windows) that affects terminal behavior and default commands, and the device's OS version. Finally, users can configure a root (e.g., sudo password for Linux) password—which grants full read/write permissions as well as maintain lists of users and services associated with the device.

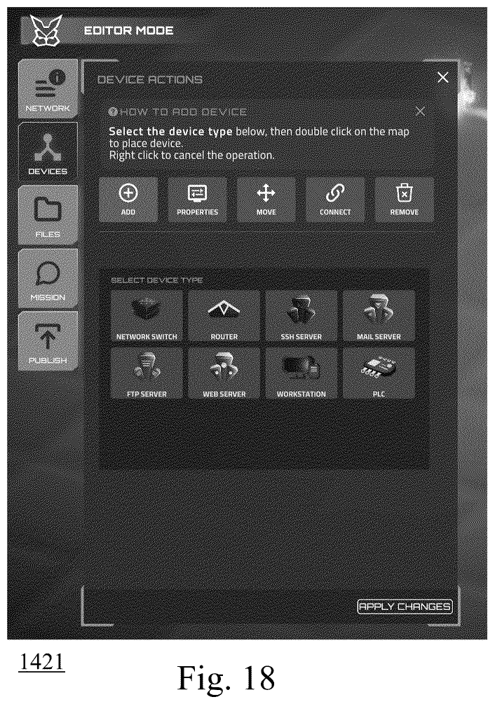

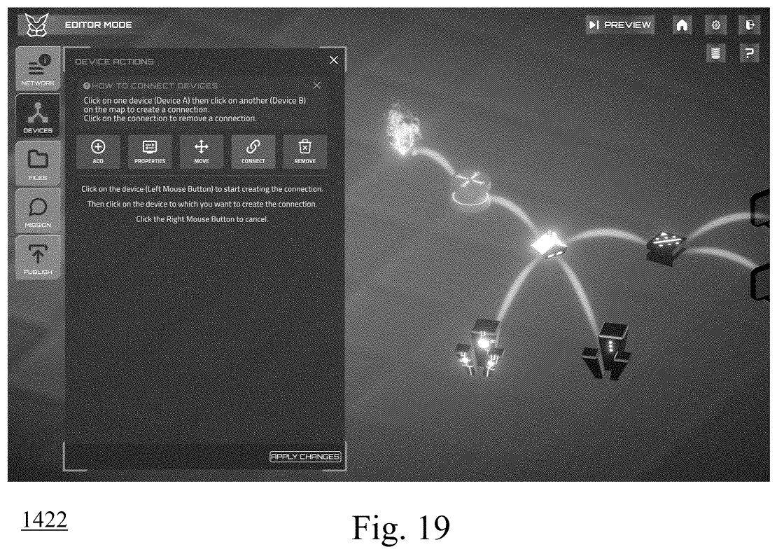

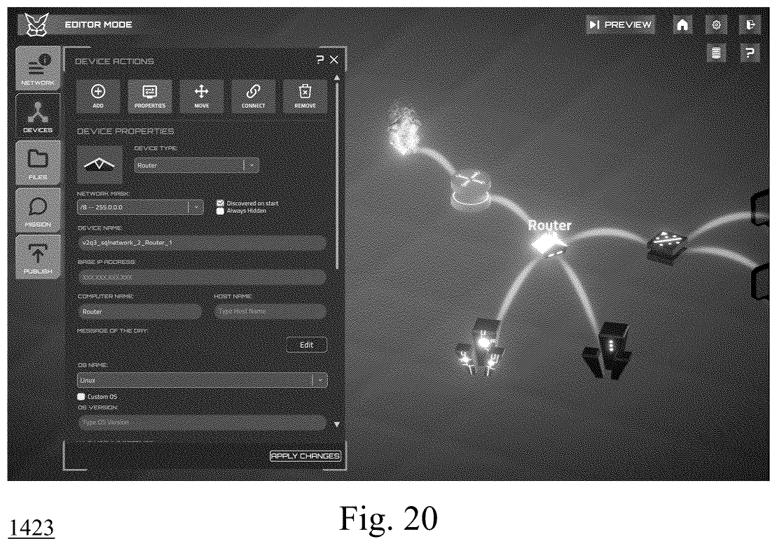

FIGS. 18-20 shows interfaces 1421, 1422 and 1423 for defining a device, respectively. In various embodiments, a creator can select a device that is wanted in the network and place the device at a desired location. The creator can then click a connect tab to define the topology. They can then select the device, which auto-selects the properties tab, where they can define device attributes. Some devices, like routers, have unique properties, like Wi-Fi settings, netmasks, etc. The properties tab can define services and device users.

A mission editor is accessed via the Files section 1405 and/or Mission section 1406, which provides access to a specific JSON file that drive all missions. The file section can contain general mission information and an ordered array of steps that the user can complete. Creators can then add files through the FILES menu option. They can define file attributes, user access permissions. FIG. 21 shows an interface 1424 for controlling the files.

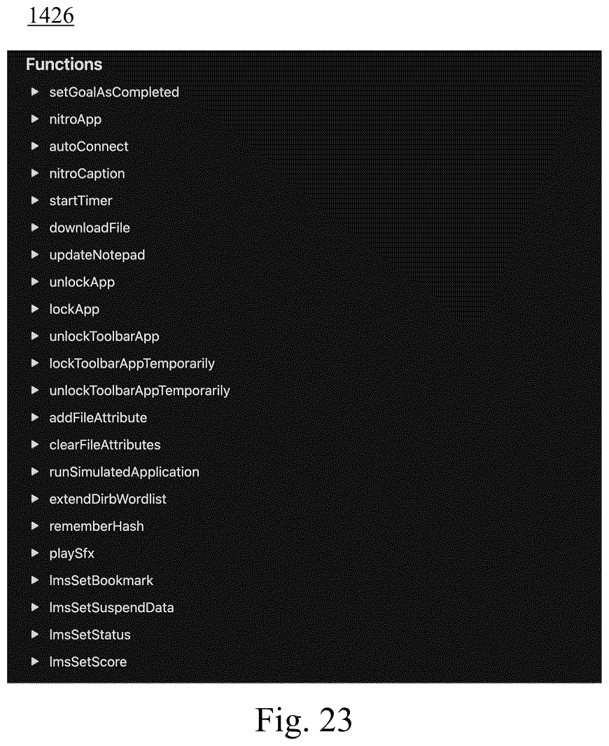

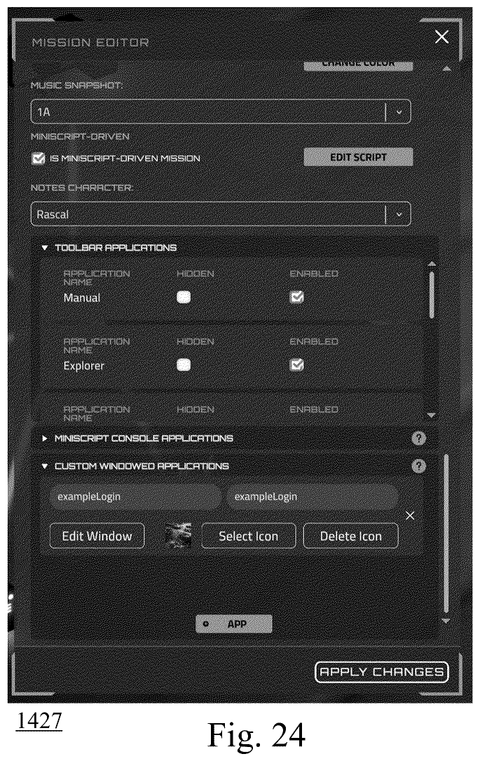

A step can include a block defining actions that influence the flow of the scenario. The system can execute a string of commands when triggered, define requirements the user must do to move onto the next step, and step type. The JSON structure includes an “Id” that serves as a unique mission identifier, along with a “MissionName” and “ObjectiveText” that provide visual information provided to the end-user as popups. It also includes a “FilesToRestore” array—used exclusively to restore attributes of pre-created files before a mission becomes active—and a “CustomNetworkName” that defines the network file name created by the system. Additionally, the JSON outlines “ToolbarAppsStates,” which control the visibility and interactivity of toolbar applications such as Manual, Explorer, Notes, SkillTree, and WebBrowser; if an app is locked, it remains hidden, and if unlocked but not enabled, it appears with a gray tint until activated via the “appbtnunlock” command. The list of steps is critical, as its definitive execution order marks the mission's start and finish, culminating in a “Mission Complete” caption when the final step is executed. Exemplary interfaces 1412, 1414, and 1415 of the mission editor of the Files section 1405 (shown in FIG. 14) and/or Mission section 1406 are shown in FIGS. 15B, 15D, and 15E, respectively. Exemplary interfaces 1427, 1428, and 1429 of the mission editor of the Mission section 1406 (shown in FIG. 14) are shown in FIGS. 24-26, respectively. The interface 1427 illustrates building, using the mission editor, a user interface to present to a trainee. The interface 1428 illustrates additional settings used in the mission edit to build the user interface. The interface 1429 illustrated a preview of a viewing effect of the user interface. The interfaces 1427, 1428, and 1429 are exemplary graphical user interfaces that a creator can develop, by using the system. specifically for an exemplary scenario. Accordingly, the interfaces 1427, 1428, and 1429 can be part of a mission building process.

Console Applications enable you to create custom command-line applications using a scripting language, such as shown in FIG. 15C. In this context, users configure the command name—used to launch the application from the terminal—which must not contain spaces, or else it will be rejected. The “Script” section houses the application's code, including all administrative functions, and it is essential to connect your application to the main mission script using a function such as dispatch_successful_command. A rich-text “Manual” is provided as a guide that can be accessed via the “man” command or through the Manual application on the toolbar, and the application accepts “Arguments” from a built-in array that always includes at least one element indicating whether it was run with superuser (sudo) rights.

FIG. 15C illustrates the interface 1413 for creating a mission, although the same interface 1413 can be used for scripting any suitable programs. Such programs can include an application (or app). The programs can be created via command line interface (CLI) and/or GUI. The app can include a program that can be loaded into the digital twin for a suitable purpose that is needed and can be accessible for the end-user to operate. Digital twin creators have the ability to either define a scenario through the story-blocks (for example, shown in FIGS. 15D and 15E), OR by code, but not both. In some embodiments, digital twin creators can have the ability to define a scenario through the story-blocks (for example, shown in FIGS. 15D and 15E), by code, or a combination thereof. Story-blocks can execute code when triggered. The story-blocks can be more linear. In various embodiments, the term linear can be identical to the narrative definition. By being linear, the story block can include one start and one end. In contrast, a script-only solution, or a solution that enable use of a script, can advantageously allow for very granular control over the logic flow of the scenario.

Windowed Applications can be created using the in-app Web Browser editor and scripting, supporting all administrative functions similar to console applications. The “Application name” should be unique and should not match any standard applications like File Editor, Explorer, Manual, Notes, or SkillTree, as it appears in the application window header and toolbar tooltip. The optional “Terminal command name” is the only means for passing parameters to the application code if required. The “Application icon” is sourced from network storage, and if it isn't set or fails to load, the application button will not appear in the top-right toolbar, though the application can still be launched via the terminal. Additionally, the “App lock state” indicates whether the windowed application is locked or unlocked (with all applications being unlocked by default), and this state can be modified using functions like lockToolbarAppTemporarily and unlockToolbarAppTemporarily. Finally, the “App script” is created and edited using the Visual Web Editor, where the visual content is handled like a regular web page, and if no background block is provided, the default window background is used—unlike the white background typically seen in Haiku Web Browser pages.

In various embodiments, a creator can go to the MISSION tab to define how the trainee is guided through the experience. The system can provide a great variety of function (including hundreds of functions, for example) that can be used to respond to trainee interactions along with interacting with every interface in the network. Each function can be controllable. FIG. 23 shows a list 1426 of exemplary functions provided by the system. In various embodiments, the list 1426 of functions is not necessarily present in any in-app interface (for example, for creating a mission, or for a user in training). However, the list 1426 can be available in documentation for a creator to use. In various embodiments, the documentation can be queryable by a client-facing AI chat system.

In various embodiments, a code-based solution can allow a creator to construct multiple paths that the trainee can take. The paths can include multiple failure states. Trainees can use any of the tools built into the platform to interact with the scenario the creator built. Stated somewhat differently, a creator uses the system as set forth in the present disclosure, and the trainees can receive a cybersecurity training. The commands can be tools that may be essential depending on the training for the trainee to use. Example commands can include hydra, Linux navigational commands, or the like. The creator can detect tool usage and respond accordingly in the scenario that is built by the creator.

However, even if the system has not built all tools in existence, the creator can script out desired customized CLI and GUI apps to include in the mission. The scripting language can be multi-purpose.

The structure of a single step in the mission is defined by several key elements. For example, when selecting the Files and Mission section 1406, users can see that each step has an “Id” that uniquely identifies it and may include a “GoalName” if reaching the step signifies goal completion; otherwise, this field is left empty. The “OrderProcessingType” determines how the step is evaluated: type 0 (CheckAndContinueToNext) requires the step to be checked in every iteration and moves to the next step if the commands fail; type 1 (ContinueToNextButNotCheck) is a Nitro Step checked only during the first iteration and skipped thereafter if it fails; type 2 (BreakIfCheck WasFailed) is a required goal that halts further processing upon failure; and type 3 (BlockOfGoals) functions as a container for multiple steps, behaving similarly to type 2. Furthermore, each step includes a “CommandsWaitingFor” array—where a match between any command and the user's input results in the step being passed and the iterator advanced—and a “CommandsWhenStart” array that lists terminal commands to be executed as the step begins. Some commands in this array may be prefixed with an exclamation mark (and optionally a hyphen) to ensure they do not interrupt the currently running command. Various flow examples illustrate these mechanisms, such as comparing user input against all required steps, evaluating only the current step while bypassing Nitro Steps, or verifying a step (like waiting for a “cd” command) only after a preceding goal has been completed.

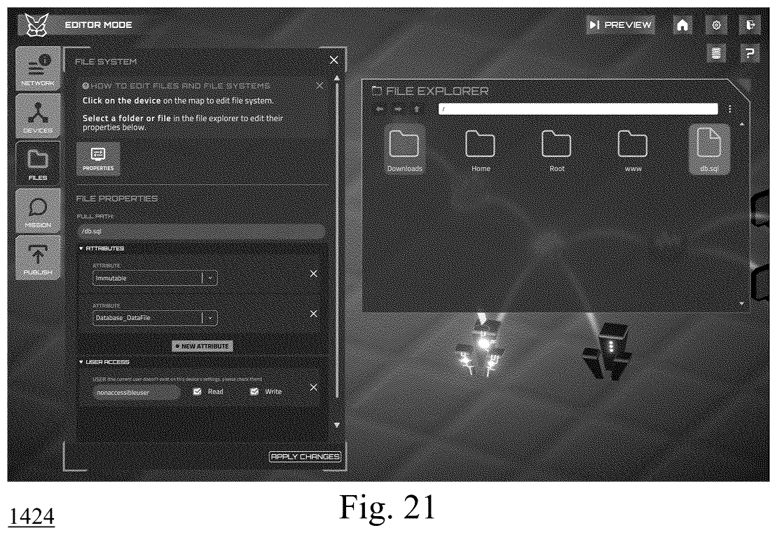

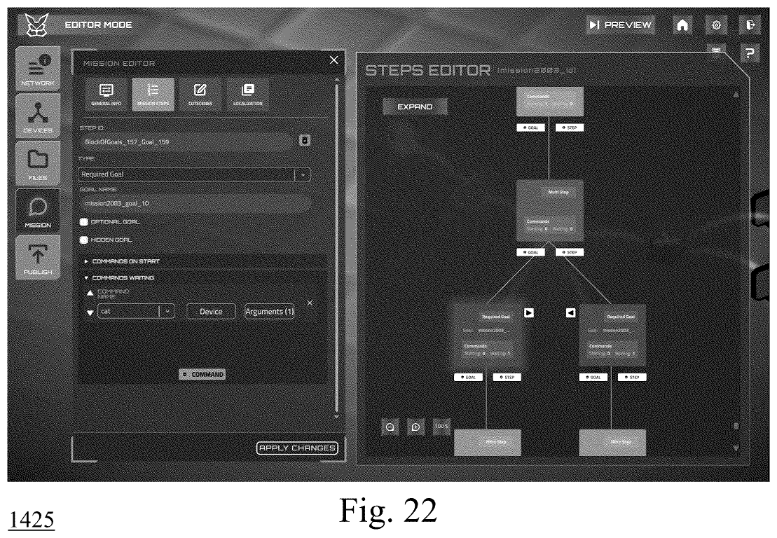

Stated somewhat differently, exemplary steps can include the following. A required step can be required to move forward in the mission, but is not a goal. A step of type 0 can include a required step. A required goal can include a written goal required to complete a mission. A step of type 2 can include a required goal. A Nitro step, also referred to as an interface message step, can include sending one or more Nitro messages not paired with an action. A step of type 1 can include a Nitro Step. A multi-step step (or container step, multi step) can include a block of steps and/or goals as set forth above, where an order is not required. A step of type 3 can include a multi step. In various embodiments, step types can dictate the color of a step shown in the interfaces 1414, 1415, and 1425 (shown in FIGS. 15D, 15E, and 22, respectively). In one embodiment, the required step can be blue, the Nitro step can be yellow, the required goal can be red, and the multi-step step can be purple. Stated somewhat differently, the different step types each can be shown in different colors, respectively, to be presented to the creator in a clear manner. The mission editor can be referred to as a steps editor. The diagrams in the interfaces 1414, 1415, and 1425 can include a visual representation of what the code (for example, code in the interface 1413) can do.

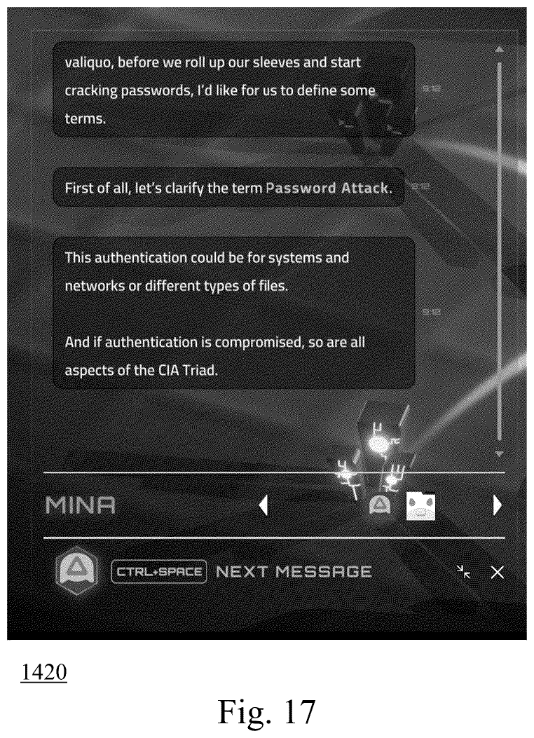

FIG. 17 shows an exemplary training chat interface (or Nitro, or Nitro interface, or Nitro message interface) 1420. The training chat interface 1420 can include a chat interface that guides the user through an experience. In various embodiments, the training chat interface 1420 can include a chat interface that is used to relay information to the end-user. Stated somewhat differently, the training chat interface 1420 can include an interface for relaying new information and responding to user behavior as determined by the scenario logic of the training. Nitro step (ContinueToNextButNotCheck) is a step that can be frequently used to chain together messages to send to the training chat interface.

In some embodiments, one or more messages shown in the training chat interface 1420 can be defined via the interface 1413 (show in FIG. 15C). The interface 1413 can include an interface section 1430 (shown in FIG. 15C) that implements a nitroApp function. Additionally and/or alternatively, the messages shown in the training chat interface 1420 can be defined via the interface 1414 (show in FIG. 15D). The interface 1414 can include an interface section 1431 (shown in FIG. 15D) that implements the nitroApp function.

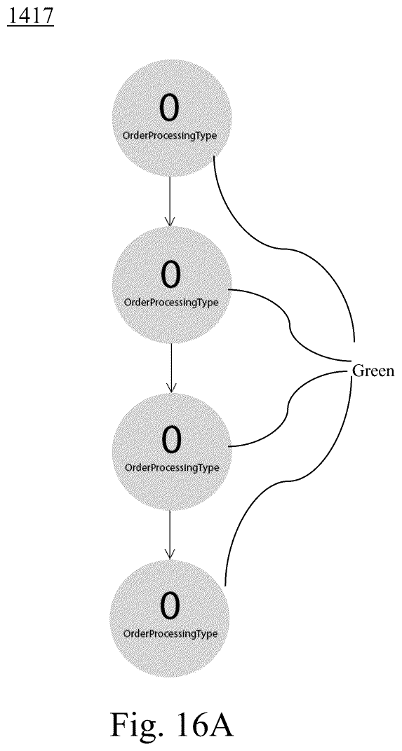

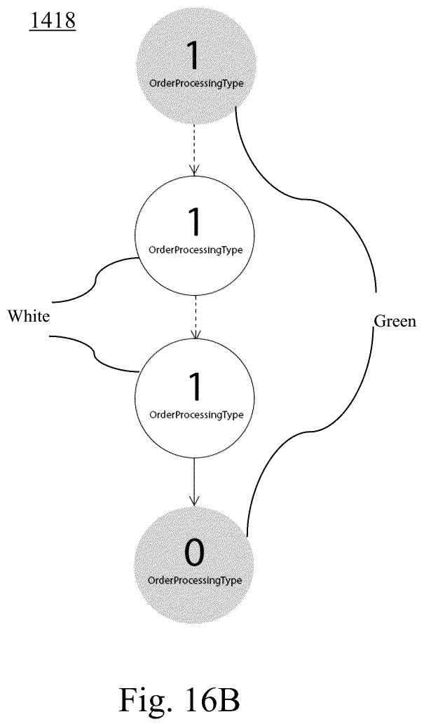

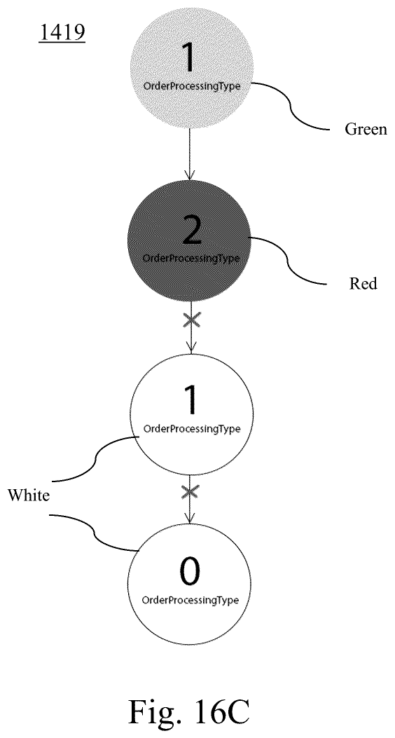

FIGS. 16A-C illustrate three exemplary flows through steps of the mission. In an exemplary flow 1417 shown in FIG. 16A, a player typed some single command, which command is compared to all Required Step (0) commands waiting for green circles for steps, which will be compared. Stated somewhat differently, the flow 1417 can be presented as an all-green diagram. The player types a single command, which is compared against all Required Step (0) commands. Green circles represent steps that are actively being checked against the player's input.

In an exemplary flow 1418 shown in FIG. 16B, the user's input is compared only with the current step, the flow will be moved further, but won't compare Nitro Step (1) steps. The blank circles are steps, which won't be compared to the player input. In a real-world example, an explanation of how to use the “cd” command is divided into 3 nitro messages. But the user understood how to use it from the first message and performed this command correctly. So the user input is checked—i.e., was it the “next message” request? If no, go further and skip all steps, which waits for the “next message” request, and checks only real-actions steps. One of these steps is the step, which waits for the “cd” command, and this step will be compared with user input. Stated somewhat differently, the flow 1418 can be presented as a green-and-white diagram. The user's input is only compared to the current step. The flow progresses but Nitro Steps (1) are skipped. White circles represent steps that are not compared to user input.

In an illustrative example, in a practical scenario, three Nitro messages can be used for explaining a “cd” command tutorial. If the user successfully uses the “cd” command after the first message, we don't wait for a “next message” input. Instead, we skip remaining Nitro steps and jump straight to checking real-action steps. In this case, the real-action step can include a step that verifies the “cd” command.

In an exemplary flow 1419 shown in FIG. 16C, assume the second circle is a goal. Until the user completes this goal, the next steps are not checked. Stated somewhat differently, the flow 1419 can be presented as a green-red-white diagram. In an illustrative example, the second circle can be a required goal. Until the user completes that goal, the system does not evaluate any subsequent steps.

Although circles in the flows 1417-1419 (shown in FIGS. 16A-16C) may be represented in selected colors, the colored circles in each flow diagram can represent a logical flow for illustrative purposes only. The circles do not correlate to the step types 0-3 (or blue, yellow, red, and purple steps, for example) as set forth above. The numbers in the circles correspond to the actual step types (for example, 0 can be a required step; 1 can be a Nitro step; and 2 can be a required goal. In various embodiments, the flows 1417-1419 can be represented in documentation or use manual to aid a creator in the understanding of step logic flow. In various embodiments, the flows 1417-1419 are not represented in a user interface.

A dedicated scripting language enables advanced story mission scripting that supports dynamic narrative control and simulates interactive user behaviors, providing fine-grained control over mission objectives and player feedback. Its features include asynchronous commands, loops, and dynamic object manipulation for creating engaging missions, while integration with the Haiku Web Browser app allows in-app scripting to modify UI elements and handle user inputs through a simulated browser environment.

Multiplayer missions are exclusively scripted to process multiple user actions dynamically. A special MultiplayerStateLog object synchronizes player actions and triggers mission events based on collaborative or competitive missions, while host-controlled debugging tools are available to monitor player actions and manage session state. A matchmaking system enables users to create rooms with customizable settings such as password protection and allow-lists, and offers features like invitation links and room lists accessible through the app menu. A host user, whether playable or non-playable, maintains session stability and accesses debug tools, with notifications and a status bar providing real-time updates on mission progress or player-specific messages. Additionally, the file system, device files, and folders can be edited through a two-part interface: the File System view allows you to edit properties for a selected file system entity (or defaults to the root folder if none is selected), while the File Explorer view provides the ability to create or delete entities and navigate the file system.

Devices in the simulated environment can host custom web pages that leverage unique HTML elements to simulate user interfaces and interactions, including input forms, buttons, and interactive graphics. Scripting functions, such as browser_create_absolute_div and browser_modify_absolute_div, enable dynamic manipulation of these browser elements to create an engaging, interactive experience.

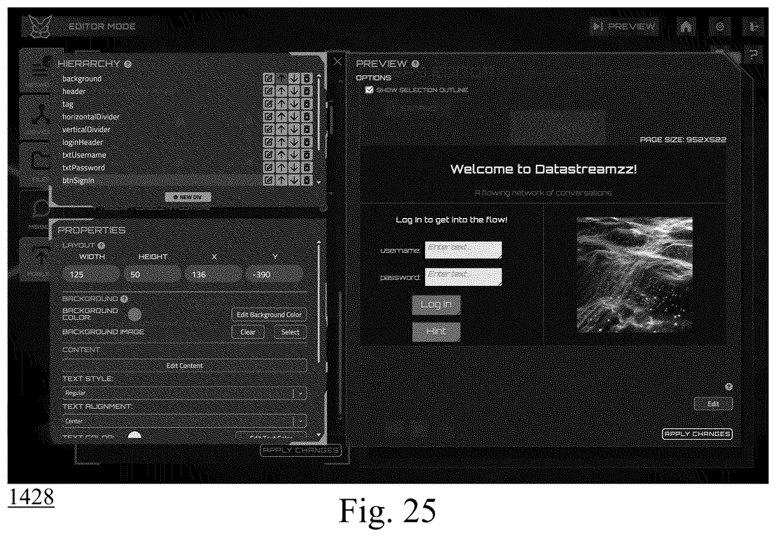

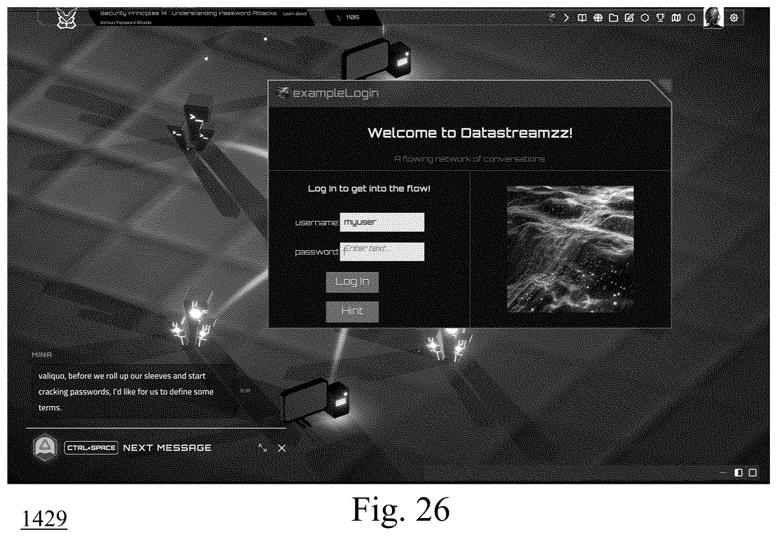

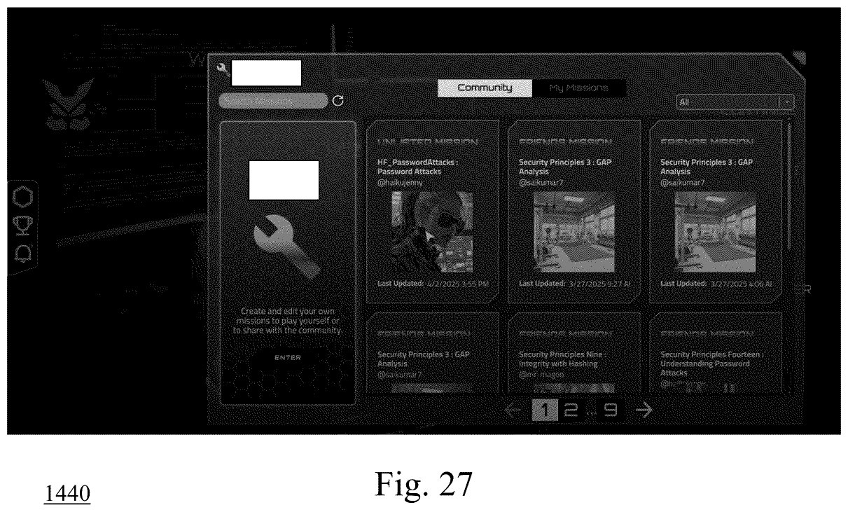

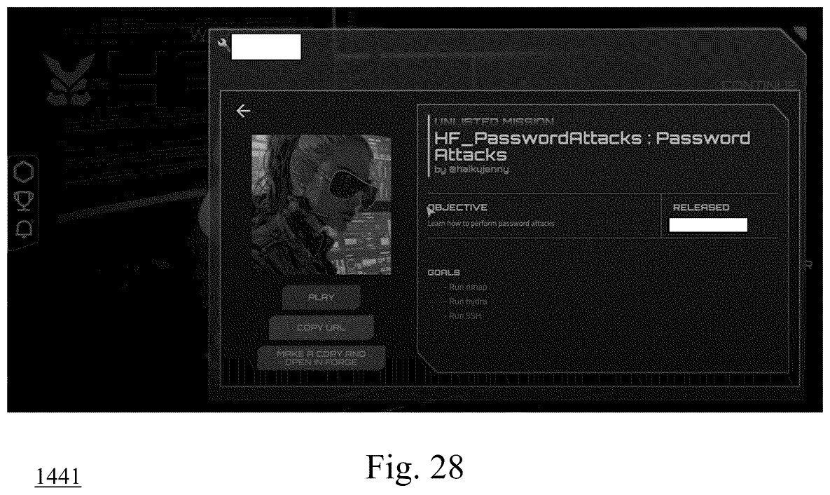

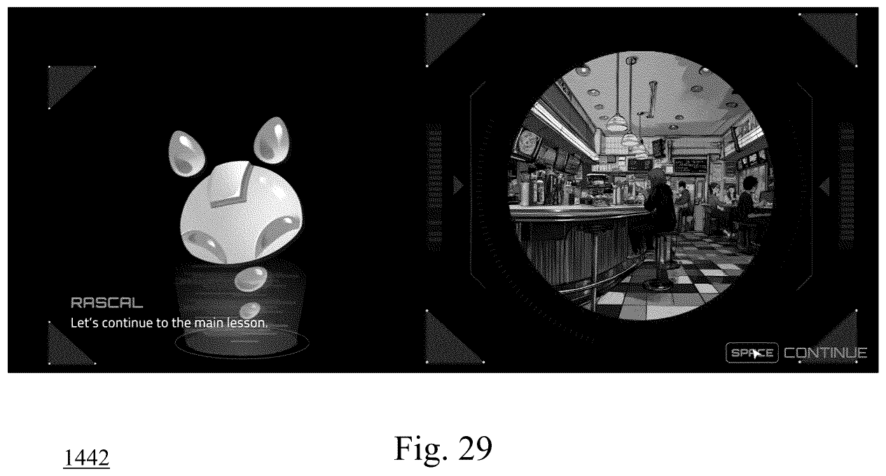

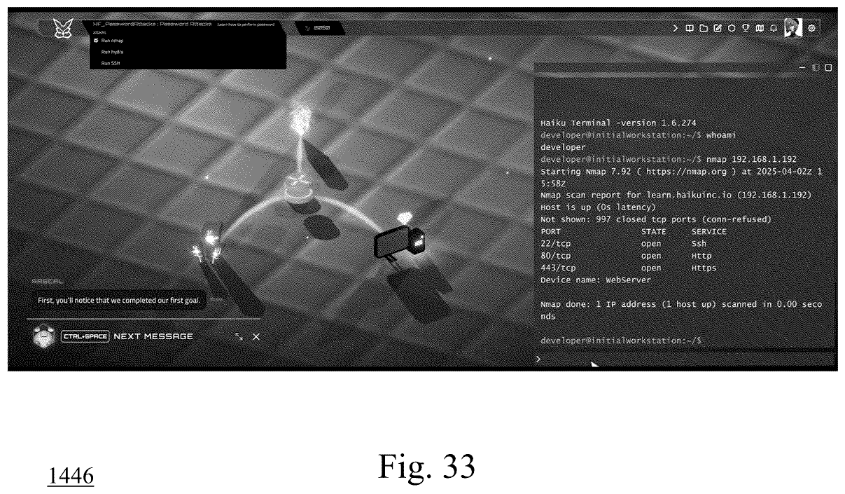

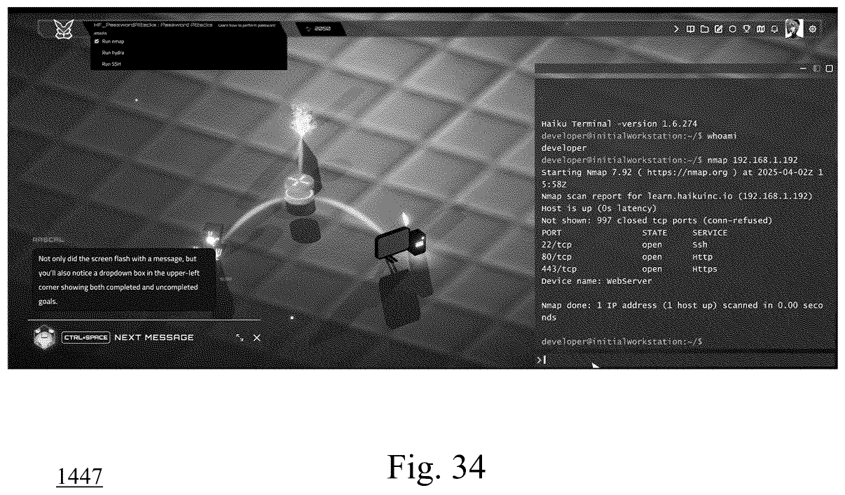

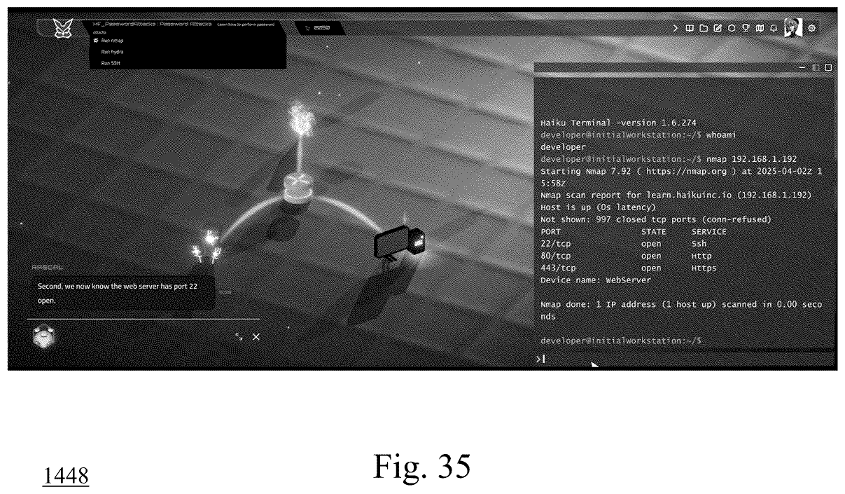

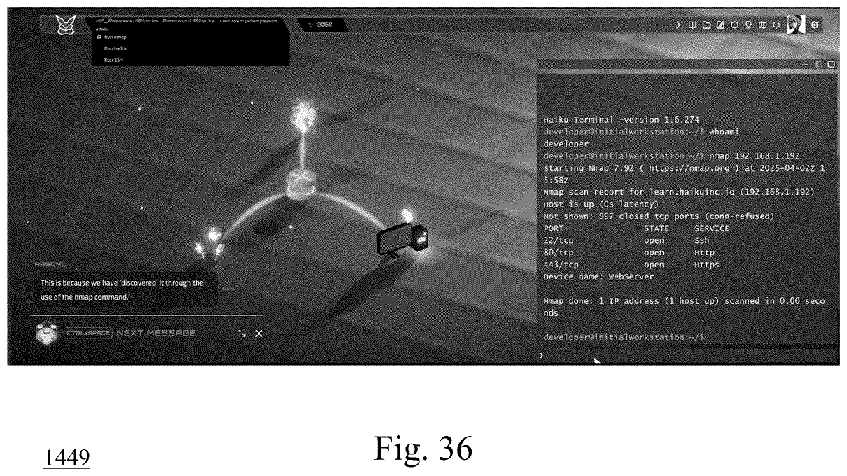

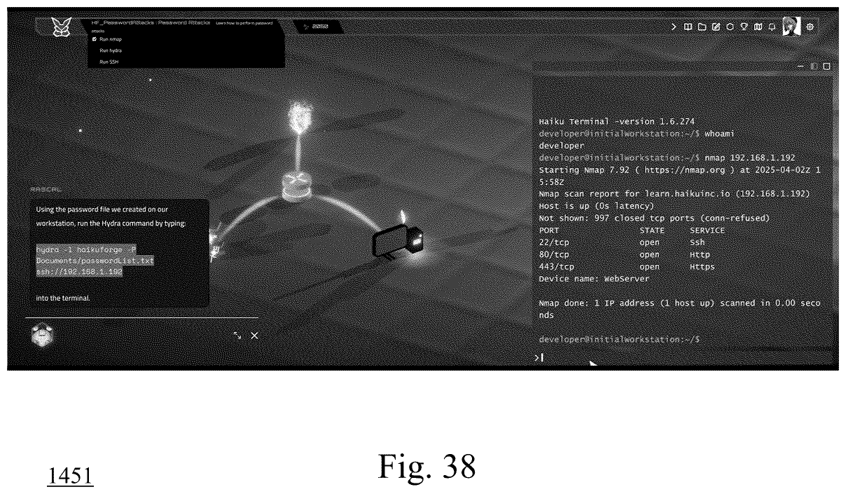

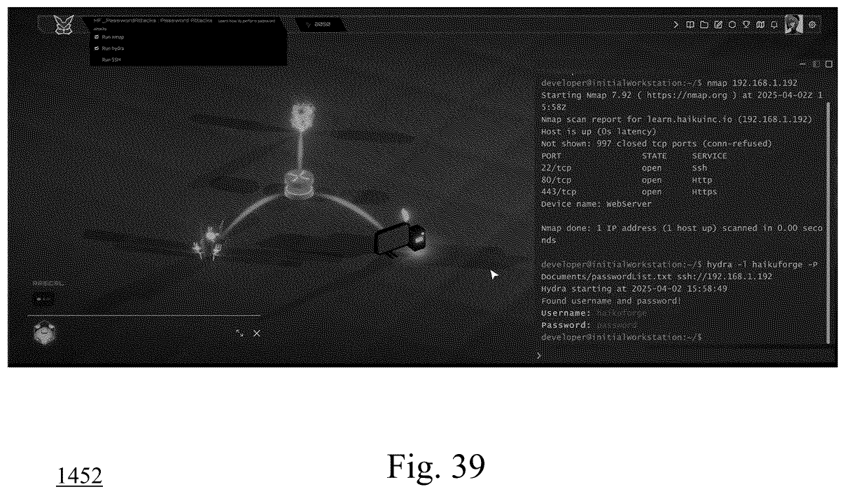

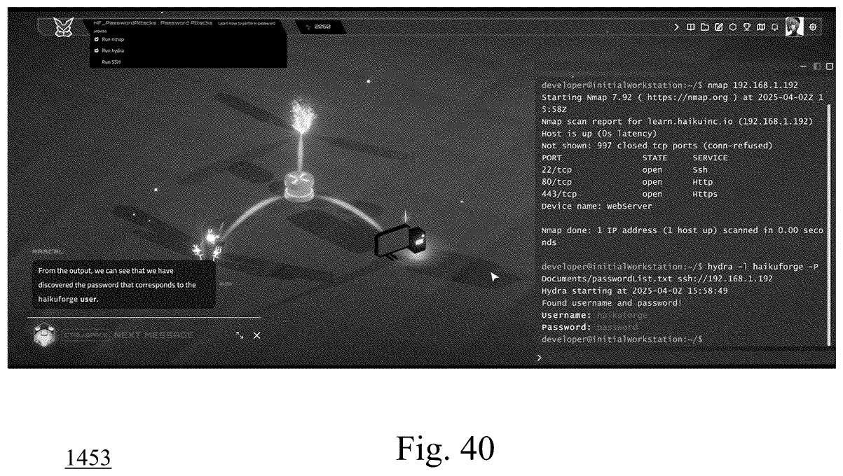

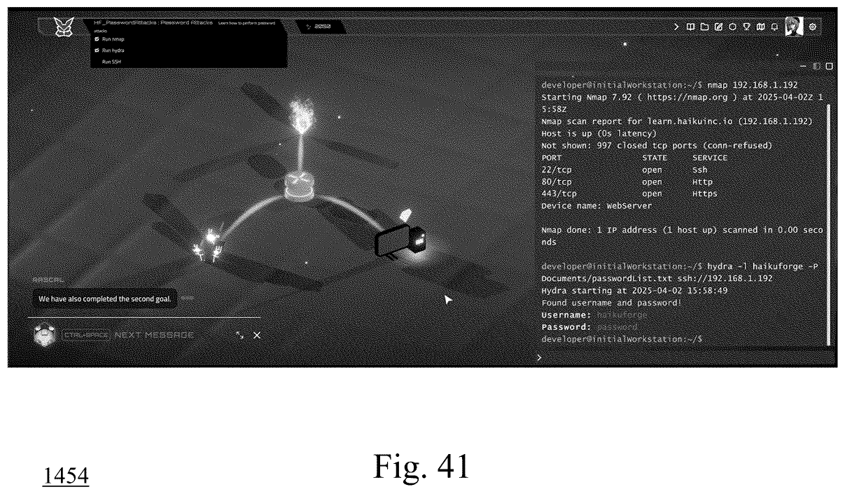

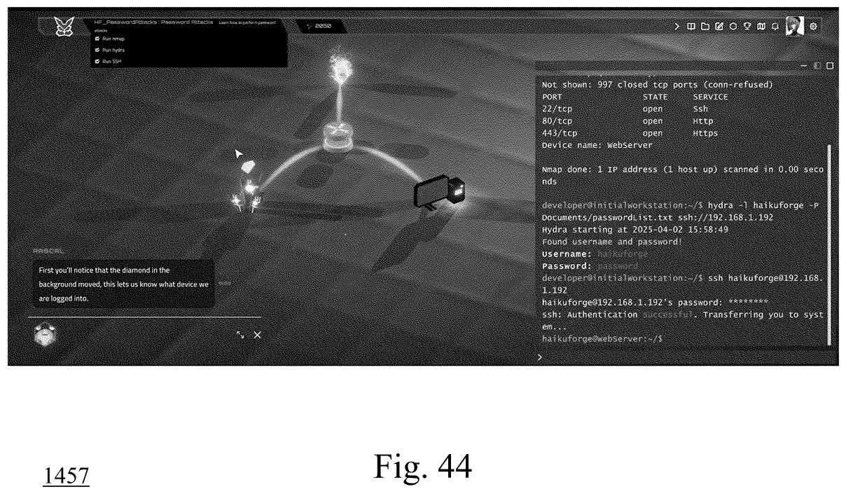

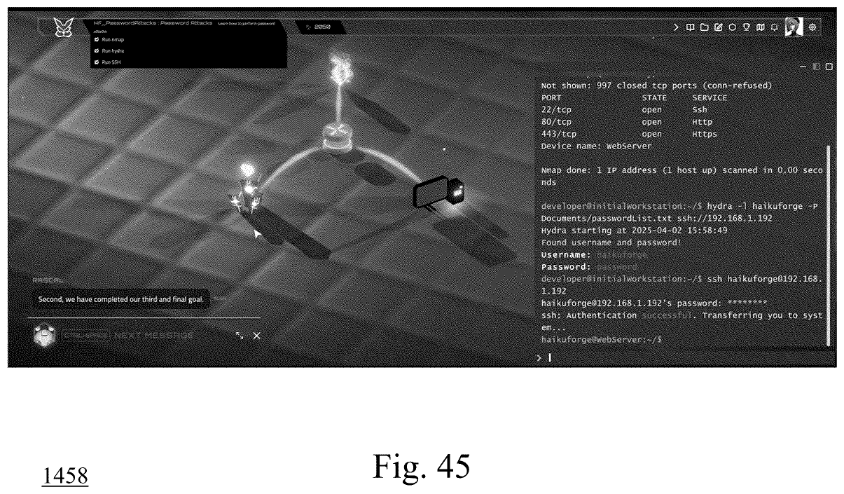

Steps created in the mission editor can correspond to effects in an experience that a trainee (or a training participant, or player) can play through. FIGS. 27-45 show exemplary player interfaces 1140-1458 that can be displayed to the trainee in an exemplary scenario for password attacks. A user interface displayed and operated by a creator of a network and/or mission can be referred to as a creator interface (or user interface for creator).

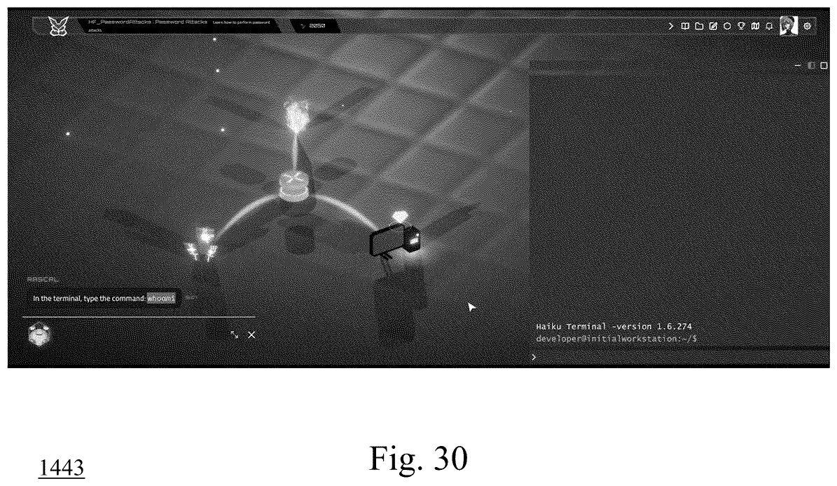

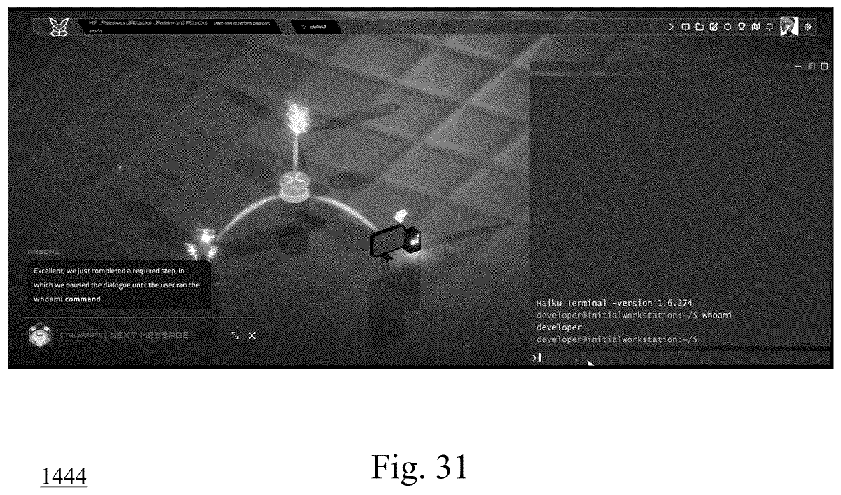

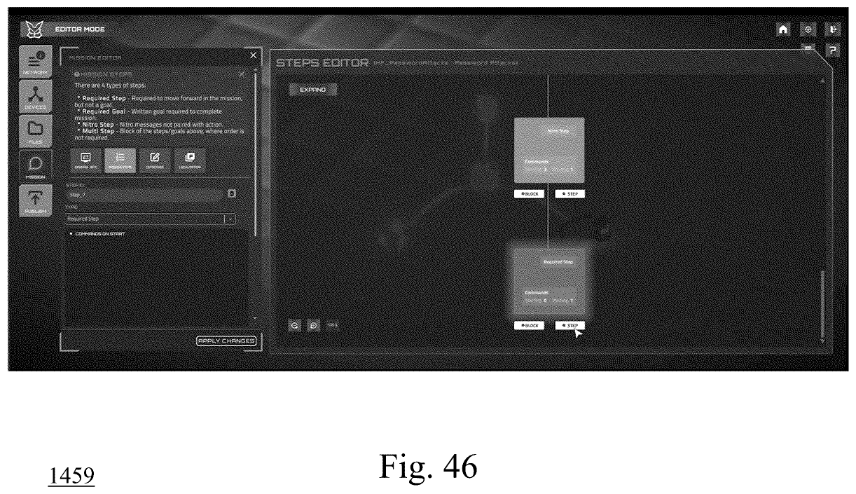

FIG. 46 shows an exemplary creator interface 1459 for creating the scenario. The creator interface 1459 can be used for building a required step associated with the player interfaces 1443, 1444 (shown in FIGS. 30-31). In this example, setting up the required step can include selecting a WHOAMI command for the step.

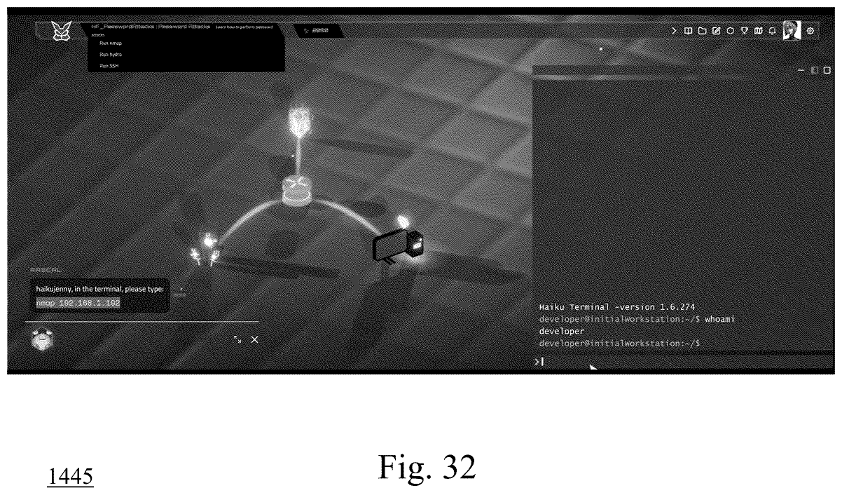

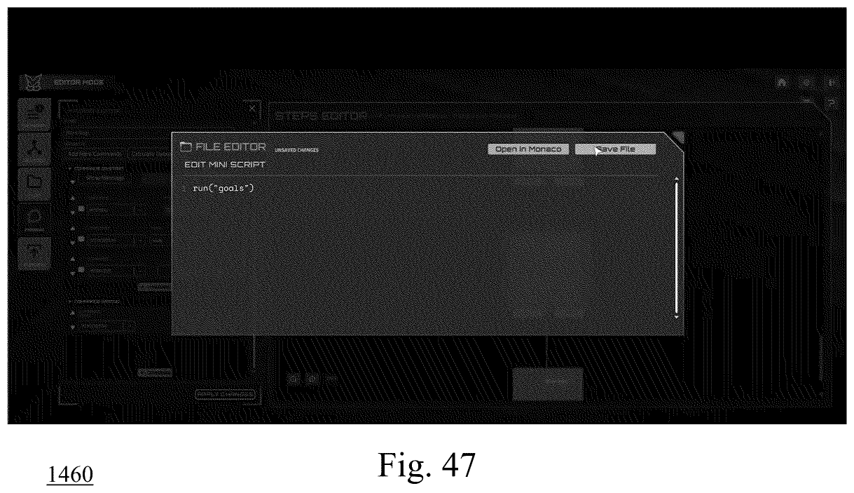

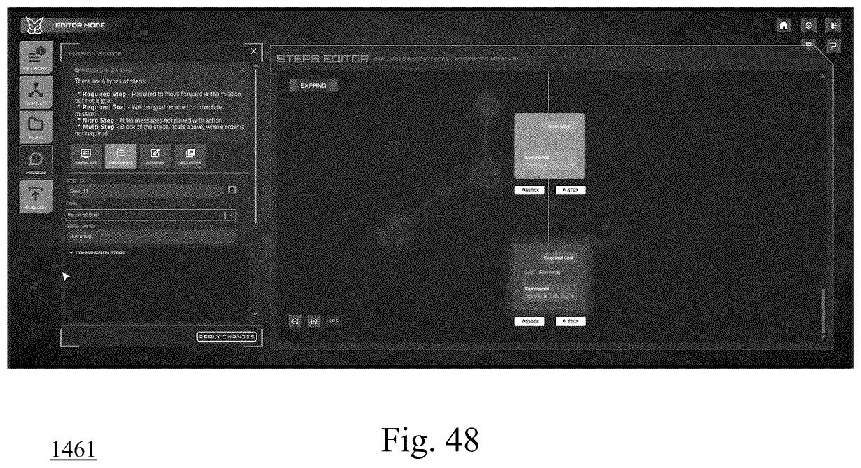

FIGS. 47 and 48 show exemplary creator interfaces 1460, 1461 for creating the scenario. The creator interfaces 1460, 1461 can be used for building a first required goal associated with the player interfaces 1445-1449 (shown in FIGS. 32-36). In this example, setting up the required goal can include selecting an NMAP command for the step.

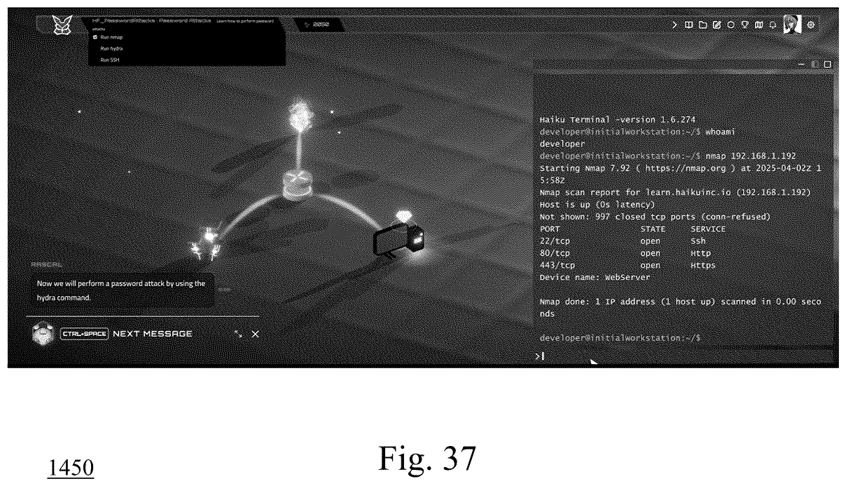

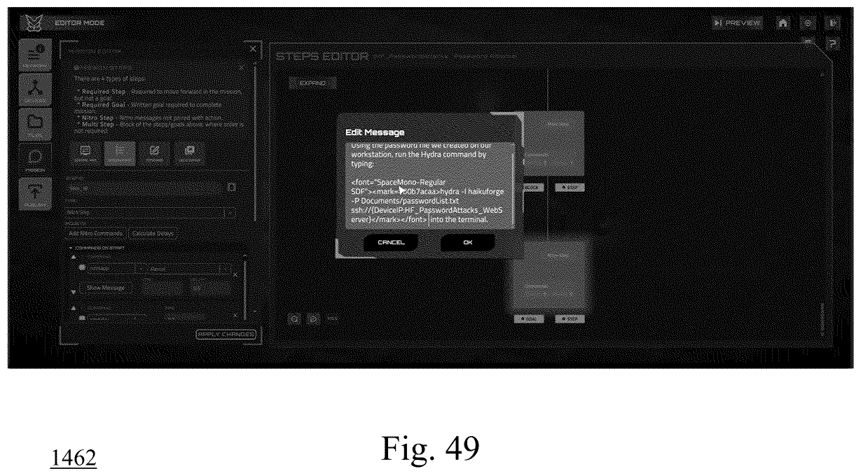

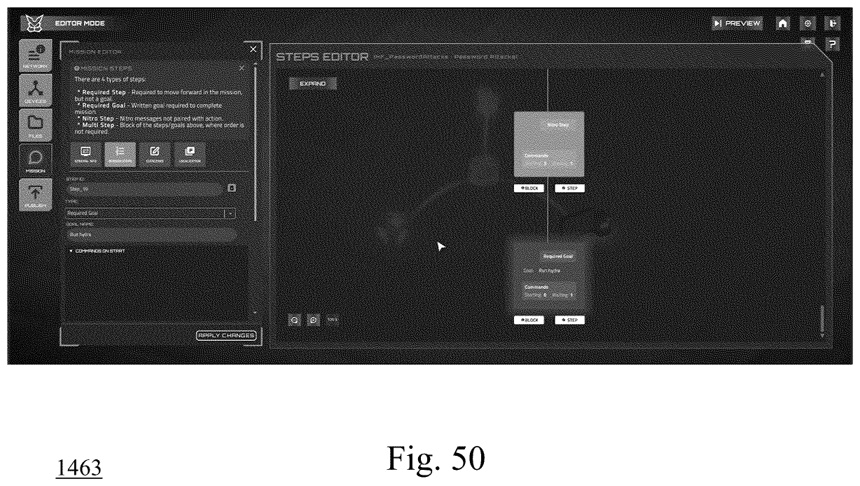

FIGS. 49 and 50 show exemplary creator interfaces 1462, 1463 for creating the scenario. The creator interfaces 1462, 1463 can be used for building a second required goal associated with the player interfaces 1450-1454 (shown in FIGS. 37-41). In this example, setting up the required goal can include selecting a HYDRA command for the step.

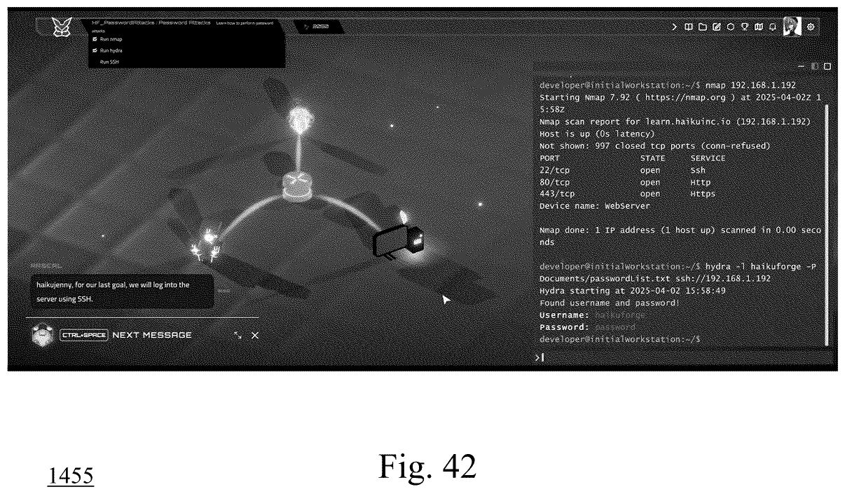

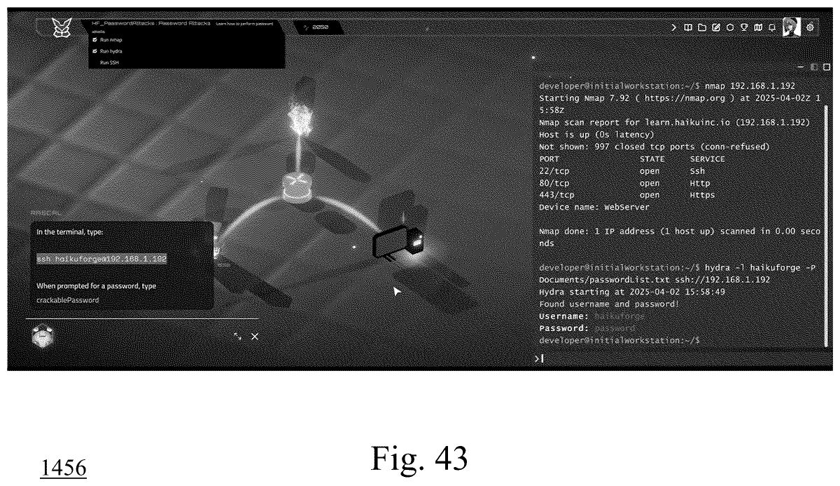

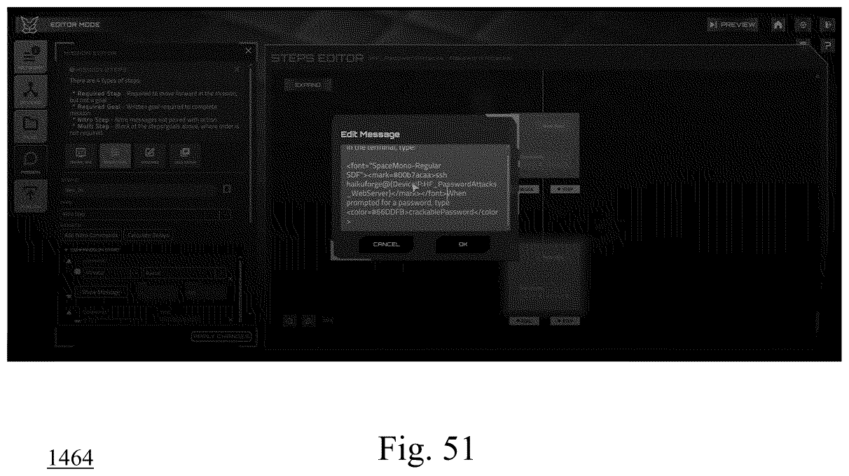

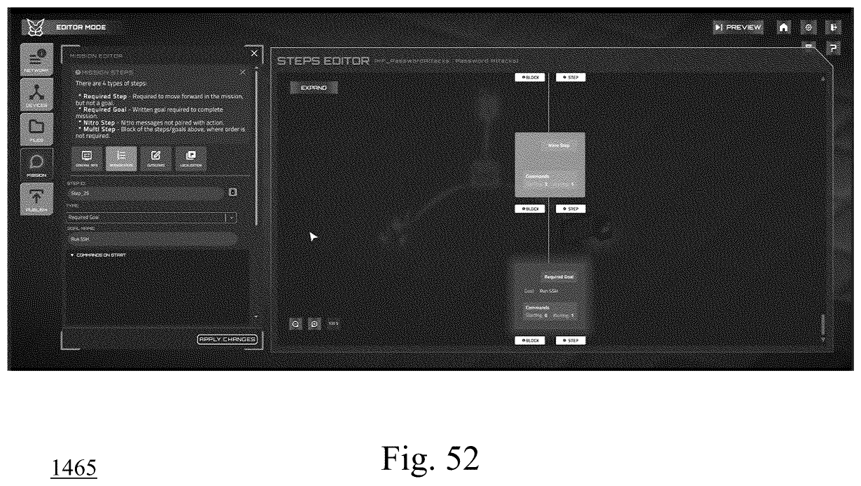

FIGS. 51 and 52 show exemplary creator interfaces 1464, 1465 for creating the scenario. The creator interfaces 1464, 1465 can be used for building a third required goal associated with the player interfaces 1455-1458 (shown in FIGS. 42-45). For example, in the player interface 1456 (shown in FIG. 43), the player is instructed to type the cracked password. In this example, setting up the required goal can include selecting an SSH command for the step.

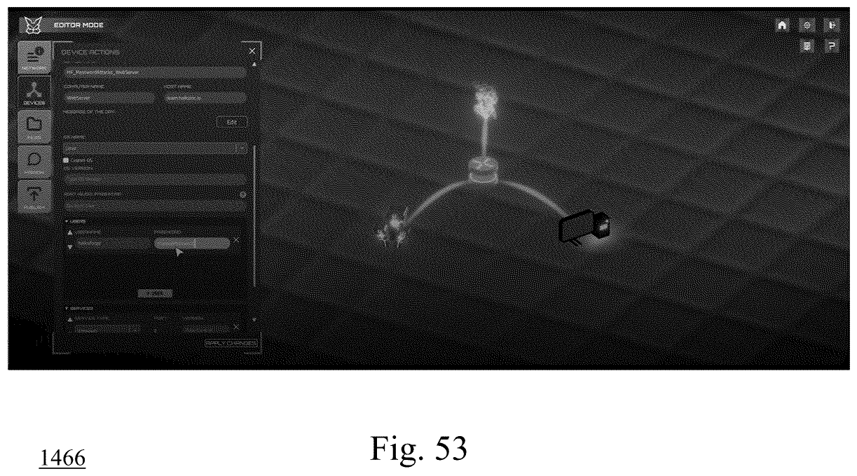

FIG. 53 shows an exemplary creator interface 1466 for a creator for building the network. The creator interface 1466 can be used for setting up a webserver that can be at least related to the third required goal. For example, the creator interface 1466 shows a “password” field where a password corresponding to the player interface 1456 (shown in FIG. 43) can be set up.

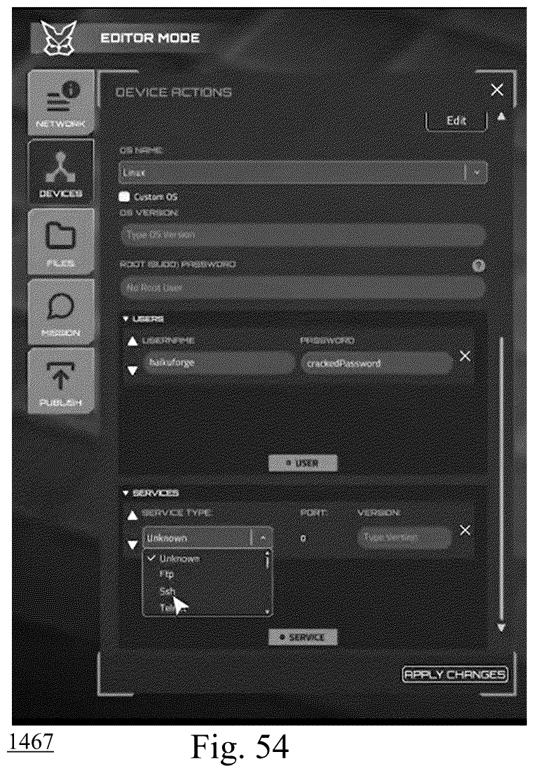

FIG. 54 shows an exemplary creator interface 1467 to illustrate further features of the webserver that can be customized. In this illustrative example, the creator interface 1467 can be a left portion of the creator interface 1466 (shown in FIG. 53) after such a left portion is scrolled down.

FIGS. 27-54 are set forth to demonstrate creating a lesson and playing through the finished experience, and to show an exemplary process end to end, for illustrative purposes only. The trainee is instructed to scan a network to find a device with an exposed SSH port and to use a low-level password list to brute force the device credentials using Hydra. The example is non-limiting, and the disclosed system can be used for simulation of threats, defenders, and a variety of other network situations, without limitation.

A Publish section 1407, such as shown in an interface 1416 that shown in FIG. 15F, provides access to the mission editor and encompasses several configuration options. A mission selecting dropdown allows you to choose a mission for publishing, while a visibility dropdown lets you set the mission's availability for other players—private (only you and friends), or public (accessible to everyone). The mission status is indicated as either Published, Unpublished, or Collaborative Editing. When an encrypted mission is enabled, the mission remains visible to other users, but they cannot use the network (or the mission) as a template; the owner retains the ability to edit and make copies, with network and story steps encrypted. Collaborative editing features include options to open a mission for editing based on the selection, download the last published version to refresh the current mission, and manage shared sources—where you can export all source files of a selected mission into a zip file or import a zip archive into the system. The Manage Access section offers dropdowns for selecting a mission and a friend, along with options to grant or revoke modification access to the selected mission. Finally, the Overview section provides general information about the mission, its goals, and its set of devices, while the Publish command starts the publishing process based on the selected publicity type, and the Preview command initiates gameplay in a standard game environment to test mission feasibility.

The system set forth game development methods to construct a scenario. In various embodiments, the system can be tailored for network and device simulation including all training interfaces for various purposes including, but not limited to, cybersecurity training, network training, operation system computer training, network building, network simulation, or a combination thereof. The digital twin as set forth above can simulate networks, operation systems, malware, protocols, and the like.

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

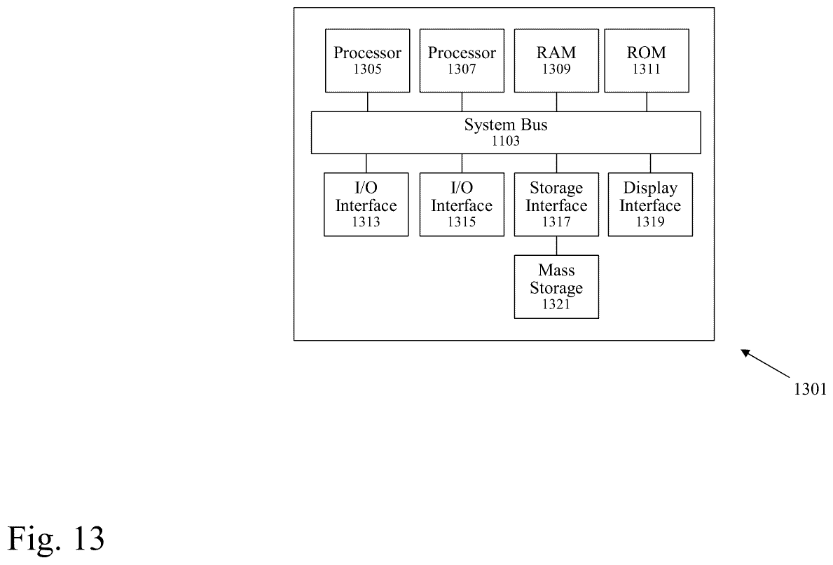

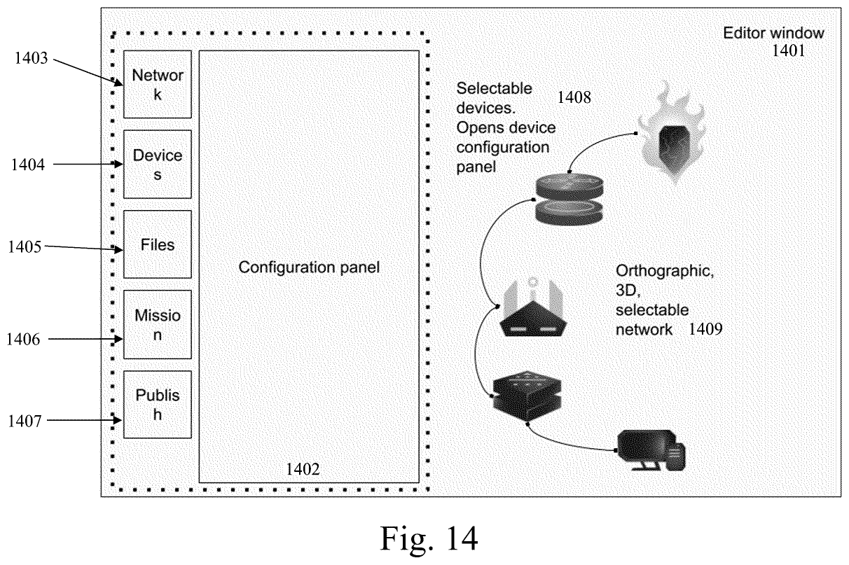

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 13 is an example computer employable in various embodiments of the present invention. Exemplary computer 1301 includes system bus 1303 which operatively connects two processors 1305 and 1307, random access memory (RAM) 1309, read-only memory (ROM) 1311, input output (I/O) interfaces 1313 and 1315, storage interface 1317, and display interface 1319. Storage interface 1317 in turn connects to mass storage 1321. Each of I/O interfaces 1313 and 1315 can, as just some examples, be a Universal Serial Bus (USB), a Thunderbolt, an Ethernet, a Bluetooth, a Long Term Evolution (LTE), an IEEE 488 and/or other interface. Mass storage 1321 can be a flash drive, a hard drive, an optical drive, or a memory chip, as just some possibilities. Processors 1305 and 1307 can each be, as just some examples, a commonly known processor such as an ARM-based or x86-based processor. Computer 1301 can, in various embodiments, include or be connected to a touch screen, a mouse, and/or a keyboard. Computer 1301 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using Python, Java, Swift, C, C++, C#, and/or another language. Corresponding program code might be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module might instead be performed by a plurality of software modules. Similarly, any operations indicated as being performed by a plurality of modules might instead be performed by a single module. It is noted that operations indicated as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A computer-implemented method for creating a digital twin that simulates a network environment, comprising:
generating at least one graphical user interface (GUI) for presentation, the GUI being configured to receive user input associated with simulating the network environment; and
building the digital twin based upon the user input received via the GUI.

2. The computer-implemented method of claim 1, wherein the GUI includes a drag-and-drop interface defining a grid for graphically presenting the digital twin.

3. The computer-implemented method of claim 2, wherein the digital twin includes at least one device corresponding to a selected element of the network environment, and the drag-and-drop interface allows dragging and dropping of the device into the grid.

4. The computer-implemented method of claim 3, wherein the device includes a web server, a router, a printer, a network switch, a firewall, a database, a storage unit, or a combination thereof.

5. The computer-implemented method of claim 3, wherein the at least one device includes at least two devices, and the GUI is configured to receive the user input on creating a network connection between the devices based upon the network environment.

6. The computer-implemented method of claim 3, wherein the user input includes a type of the device, whether the device is discovered at a start of a mission or not, or a combination thereof.

7. The computer-implemented method of claim 3, wherein the device includes a router, and the user input includes a selection of a network mask for the router.

8. The computer-implemented method of claim 7, further comprising activating, upon a determination that a Network Address Translation is activated on the digital twin, a wireless fidelity (Wi-Fi) module of the router.

9. The computer-implemented method of claim 1, wherein the digital twin includes a cyber range configured for cybersecurity training associated with the network environment.

10. The computer-implemented method of claim 9, wherein the GUI presents a mission editor for receiving the user input on creating a mission to be completed in the cybersecurity training.

11. The computer-implemented method of claim 10, wherein the GUI is configured to receive the user input from a plurality of users to collaboratively edit the mission, the digital twin, or a combination thereof.

12. The computer-implemented method of claim 10, wherein the GUI is configured to receive the user input on defining at least one step of the mission.

13. The computer-implemented method of claim 12, wherein the user input includes an order processing type of the step, the order processing type defining how the step is evaluated in a flow of the mission.

14. The computer-implemented method of claim 10, wherein the GUI includes a user interface for editing a script of the mission.

15. The computer-implemented method of claim 10, further comprising encrypting the mission and the network such that:
only an owner of the mission has an ability to edit and copy the mission; and
a user that is not the owner is permitted to view the mission but not permitted to use the network as a template.

16. A system for creating a digital twin that simulates a network environment, comprising a server computer that operates to:
generate at least one graphical user interface (GUI) for presentation, the GUI being configured to receive user input associated with simulating the network environment; and
build the digital twin based upon the user input received via the GUI.

17. The system of claim 16, wherein said server computer stores a network configuration file that defines a network functionality in the digital twin.

18. The system of claim 17, wherein the network configuration file is encrypted on said server computer.

19. The system of claim 16, wherein the digital twin includes at least one device corresponding to a selected element of the network environment, and said server computer stores a script file that includes instruction for defining a behavior of the device.

20. A computer program product for creating a digital twin that simulates a network environment, the computer program product being encoded on one or more machine-readable storage media and comprising:
instruction for generating at least one graphical user interface (GUI) for presentation, the GUI being configured to receive user input associated with simulating the network environment; and
instruction for building the digital twin based upon the user input received via the GUI.
